(19) United States
(12) Patent Application Publication
(10) Pub. No.: US 2026/0361506 A1
(43) Pub. Date: Nov. 12, 2026

(54) CROSS-LINK INTERFERENCE MEASUREMENT CONDITIONS

(71) Applicant: QUALCOMM Incorporated, San Diego, CA (US)

(72) Inventors: Prashant SHARMA, San Marcos, CA (US); Muhammad Sayed Khairy ABDELGHAFFAR, San Jose, CA (US); Qian ZHANG, Basking Ridge, NJ (US); Jae Ho RYU, San Diego, CA (US)

(21) Appl. No.: 19/669,561

(22) Filed: May 6, 2026

Related U.S. Application Data
(60) Provisional application No. 63/802,156, filed on May 8, 2025.

(51) Int. Cl. H04L 5/14; H04L 5/00; H04W 72/541

(52) U.S. Cl. CPC H04L 5/14; H04L 5/0094; H04W 72/541

(57) ABSTRACT

Various aspects of the present disclosure generally relate to wireless communication. In some aspects, a network entity may receive first information indicating that a first cross-link interference (CLI) measurement resource is to occur in a first subband full duplex (SBFD) time interval. The network entity may receive second information indicating that a second CLI measurement resource is to occur in a second SBFD time interval. The network entity may perform, in accordance with a condition, one or more CLI measurements using at least one of the first CLI measurement resource or the second CLI measurement resource, wherein the condition is evaluated based on the first SBFD time interval and the second SBFD time interval. Numerous other aspects are described.

### CROSS-REFERENCE TO RELATED APPLICATION

This Patent Application claims priority to U.S. Provisional Patent Application No. 63/802,156, filed on May 8, 2025, entitled “CROSS-LINK INTERFERENCE MEASUREMENT CONDITIONS,” and assigned to the assignee hereof. The disclosure of U.S. Provisional Patent Application No. 63/802,156 is considered part of and is incorporated by reference into this Patent Application in its entirety.

### FIELD OF THE DISCLOSURE

Aspects of the present disclosure generally relate to wireless communication and specifically relate to techniques, apparatuses, and methods associated with cross-link interference (CLI) measurement conditions.

### INTRODUCTION

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Subband full-duplex (SBFD) technology may enable a network node to simultaneously communicate with two or more user equipments (UEs). For example, the network node may receive a first communication from a first UE and transmit a second communication to a second UE on different frequency resources. If the UEs are near each other, then inter-UE cross-link interference (CLI) may occur (for example, the first UE may transmit an uplink communication that interferes with a reception at the second UE). Accordingly, a UE may measure and transmit a report of CLI.

### SUMMARY

Some aspects described herein relate to a network entity. The network entity may include a processing system. The processing system may be configured to receive first information indicating that a first cross-link interference (CLI) measurement resource is to occur in a first subband of a first subband full duplex (SBFD) time interval. The processing system may be configured to receive second information indicating that a second CLI measurement resource is to occur in a second subband of a second SBFD time interval. The processing system may be configured to perform, in accordance with a condition, one or more CLI measurements using at least one of the first CLI measurement resource or the second CLI measurement resource, wherein the condition is evaluated based on the first SBFD time interval and the second SBFD time interval.

Some aspects described herein relate to a first network entity. The first network entity may include a processing system. The processing system may be configured to transmit first information, for a second network entity, indicating that a first CLI measurement resource is to occur in a first subband of a first SBFD time interval. The processing system may be configured to transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval.

Some aspects described herein relate to a network entity. The network entity may include a processing system. The processing system may be configured to receive first information indicating a first bandwidth part (BWP). The processing system may be configured to receive second information indicating that a CLI measurement resource is to occur in one or more subbands of a first SBFD time interval. The processing system may be configured to perform, using the CLI measurement resource, one or more CLI measurements to obtain CLI measurement information, wherein one or more parameters of the CLI measurement information are based on the first BWP and the one or more subbands. The processing system may be configured to transmit third information indicating the CLI measurement information.

Some aspects described herein relate to a network entity. The network entity may include a processing system. The processing system may be configured to transmit first information indicating a first BWP. The processing system may be configured to transmit second information indicating that a CLI measurement resource is to occur in one or more subbands of a first SBFD time interval. The processing system may be configured to receive third information indicating CLI measurement information, wherein one or more parameters of the CLI measurement information are based on the first BWP and the one or more subbands.

Some aspects described herein relate to a method of wireless communication performed by a network entity. The method may include receiving first information indicating that a first CLI measurement resource is to occur in a first subband of a first SBFD time interval. The method may include receiving second information indicating that a second CLI measurement resource is to occur in a second subband of a second SBFD time interval. The method may include performing, in accordance with a condition, one or more CLI measurements using at least one of the first CLI measurement resource or the second CLI measurement resource, wherein the condition is evaluated based on the first SBFD time interval and the second SBFD time interval.

Some aspects described herein relate to a method of wireless communication performed by a first network entity. The method may include transmitting first information, for a second network entity, indicating that a first CLI measurement resource is to occur in a first subband of a first SBFD time interval. The method may include transmitting, based on a condition being satisfied, second information, for the second network entity, indicating that a second CLI measurement resource is to occur in a second subband of a second SBFD time interval, wherein the condition is evaluated based on the first SBFD time interval and the second SBFD time interval.

Some aspects described herein relate to a method of wireless communication performed by a network entity. The method may include receiving first information indicating a first BWP. The method may include receiving second information indicating that a CLI measurement resource is to occur in one or more subbands of a first SBFD time interval. The method may include performing, using the CLI measurement resource, one or more CLI measurements to obtain CLI measurement information, wherein one or more parameters of the CLI measurement information are based on the first BWP and the one or more subbands. The method may include transmitting third information indicating the CLI measurement information.

Some aspects described herein relate to a method of wireless communication performed by a network entity. The method may include transmitting first information indicating a first BWP. The method may include transmitting second information indicating that a CLI measurement resource is to occur in one or more subbands of a first SBFD time interval. The method may include receiving third information indicating CLI measurement information, wherein one or more parameters of the CLI measurement information are based on the first BWP and the one or more subbands.

Some aspects described herein relate to an apparatus for wireless communication. The apparatus may include means for receiving first information indicating that a first CLI measurement resource is to occur in a first subband of a first SBFD time interval. The apparatus may include means for receiving second information indicating that a second CLI measurement resource is to occur in a second subband of a second SBFD time interval. The apparatus may include means for performing, in accordance with a condition, one or more CLI measurements using at least one of the first CLI measurement resource or the second CLI measurement resource, wherein the condition is evaluated based on the first SBFD time interval and the second SBFD time interval.

Some aspects described herein relate to an apparatus for wireless communication. The apparatus may include means for transmitting first information, for a second apparatus, indicating that a first CLI measurement resource is to occur in a first subband of a first SBFD time interval. The apparatus may include means for transmitting, based on a condition being satisfied, second information, for the second apparatus, indicating that a second CLI measurement resource is to occur in a second subband of a second SBFD time interval, wherein the condition is evaluated based on the first SBFD time interval and the second SBFD time interval.

Some aspects described herein relate to an apparatus for wireless communication. The apparatus may include means for receiving first information indicating a first BWP. The apparatus may include means for receiving second information indicating that a CLI measurement resource is to occur in one or more subbands of a first SBFD time interval. The apparatus may include means for performing, using the CLI measurement resource, one or more CLI measurements to obtain CLI measurement information, wherein one or more parameters of the CLI measurement information are based on the first BWP and the one or more subbands. The apparatus may include means for transmitting third information indicating the CLI measurement information.

Some aspects described herein relate to an apparatus for wireless communication. The apparatus may include means for transmitting first information indicating a first BWP. The apparatus may include means for transmitting second information indicating that a CLI measurement resource is to occur in one or more subbands of a first SBFD time interval. The apparatus may include means for receiving third information indicating CLI measurement information, wherein one or more parameters of the CLI measurement information are based on the first BWP and the one or more subbands.

Some aspects described herein relate to a non-transitory computer-readable medium having code stored thereon. The code, when executed by a network entity, may cause the network entity to receive first information indicating that a first CLI measurement resource is to occur in a first subband of a first SBFD time interval. The code, when executed by a network entity, may cause the network entity to receive second information indicating that a second CLI measurement resource is to occur in a second subband of a second SBFD time interval. The code, when executed by a network entity, may cause the network entity to perform, in accordance with a condition, one or more CLI measurements using at least one of the first CLI measurement resource or the second CLI measurement resource, wherein the condition is evaluated based on the first SBFD time interval and the second SBFD time interval.

Some aspects described herein relate to a non-transitory computer-readable medium having code stored thereon. The code, when executed by a network entity, may cause the network entity to transmit first information, for a second network entity, indicating that a first CLI measurement resource is to occur in a first subband of a first SBFD time interval. The code, when executed by a network entity, may cause the network entity to transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval.

Some aspects described herein relate to a non-transitory computer-readable medium having code stored thereon. The code, when executed by a network entity, may cause the network entity to receive first information indicating a first BWP. The code, when executed by a network entity, may cause the network entity to receive second information indicating that a CLI measurement resource is to occur in one or more subbands of a first SBFD time interval. The code, when executed by a network entity, may cause the network entity to perform, using the CLI measurement resource, one or more CLI measurements to obtain CLI measurement information, wherein one or more parameters of the CLI measurement information are based on the first BWP and the one or more subbands. The code, when executed by a network entity, may cause the network entity to transmit third information indicating the CLI measurement information.

Some aspects described herein relate to a non-transitory computer-readable medium having code stored thereon. The code, when executed by a network entity, may cause the network entity to transmit first information indicating a first BWP. The code, when executed by a network entity, may cause the network entity to transmit second information indicating that a CLI measurement resource is to occur in one or more subbands of a first SBFD time interval. The code, when executed by a network entity, may cause the network entity to receive third information indicating CLI measurement information, wherein one or more parameters of the CLI measurement information are based on the first BWP and the one or more subbands.

The systems, methods, and devices of this disclosure each have several innovative aspects, no single one of which is solely responsible for the desirable attributes disclosed herein.

Aspects generally include a method, apparatus, system, computer program product, non-transitory computer-readable medium, user equipment, base station, network entity, network node, wireless communication device, or processing system as substantially described herein with reference to and as illustrated by the drawings and specification.

The foregoing broadly outlines example features and example technical advantages of examples according to the disclosure. Additional example features and example advantages are described hereinafter.

### BRIEF DESCRIPTION OF THE DRAWINGS

FIG. 1 is a diagram illustrating an example environment in which apparatuses or methods described herein may be implemented.

FIG. 2 is a diagram illustrating an example of a wireless communication network.

FIG. 3 is a diagram illustrating examples of full-duplex communication in a wireless network.

FIG. 4 is a diagram illustrating examples associated with subband full-duplex (SBFD) operation at a network node.

FIG. 5 is a diagram illustrating examples of cross-link interference (CLI).

FIG. 6 is a diagram illustrating an example of CLI measurements.

FIG. 7 is a diagram of an example associated with CLI measurement conditions.

FIG. 8 is a diagram of an example associated with CLI measurement conditions.

FIG. 9 is a diagram of an example associated with CLI measurement conditions.

FIG. 10 is a diagram of an example associated with CLI measurement conditions.

FIG. 11 is a diagram of an example associated with CLI measurement.

FIG. 12 is a diagram of an example associated with CLI measurement.

FIG. 13 is a diagram of an example associated with CLI measurement.

FIG. 14 is a diagram illustrating an example process performed, for example, at a network entity or an apparatus of a network entity.

FIG. 15 is a diagram illustrating an example process performed, for example, at a network entity or an apparatus of a network entity.

FIG. 16 is a diagram illustrating an example process performed, for example, at a network entity or an apparatus of a network entity.

FIG. 17 is a diagram illustrating an example process performed, for example, at a network entity or an apparatus of a network entity.

FIG. 18 is a diagram of an example apparatus for wireless communication.

FIG. 19 is a diagram of an example apparatus for wireless communication.

### DETAILED DESCRIPTION

In subband full-duplex (SBFD) systems, a network node may simultaneously receive uplink communications and transmit downlink communications on different frequency resources. For example, a user equipment (UE) may transmit an uplink signal in an uplink subband in a downlink-only slot or a flexible slot. For example, SBFD may enable frequency-division duplexing in time intervals configured with time-division duplexing (TDD). As a result, SBFD operation may increase an uplink duty cycle, improve uplink coverage, and reduce latency. However, SBFD operation may allow messages to be transmitted on nearby links at the same time, which may give rise to cross-link interference (CLI). For SBFD communications, CLI may include inter-subband (inter-SB) CLI between subbands, intra-cell CLI within a cell, inter-cell CLI between different cells, or inter-UE CLI between UEs. CLI may also include inter-gNB CLI between network nodes (for example, gNBs).

A UE may use a CLI measurement resource to measure CLI. The CLI measurement resource may include one or more of a time resource, a frequency resource, or a beam, among other examples. For example, the CLI measurement resource may be a sounding reference signal (SRS) reference signal received power (RSRP) (SRS-RSRP) measurement resource for RSRP measurements of CLI, or a CLI received signal strength indicator (RSSI) (CLI-RSSI) measurement resource for RSSI measurements of CLI, among other examples. The UE may take CLI measurements using the CLI measurement resource and generate a CLI report that indicates the CLI measurements. The UE may transmit the CLI report (for example, in a channel state information (CSI) report) to a network node. In some examples, both the CLI measurement resources and the CLI reporting may be aperiodic.

For inter-UE CLI, a layer 1 (L1) based UE-to-UE CLI measurement and reporting may be based on a CSI framework. The L1 based UE-to-UE CLI measurement and reporting may involve measurement resources. The measurement resources may include periodic, semi-persistent, or aperiodic measurement resources (or resource sets) (e.g., SRS-RSRP measurement resources or CLI-RSSI measurement resources). The L1 based UE-to-UE CLI measurement and reporting may involve measurement reporting, which may include aperiodic, periodic, or semi-persistent reporting. Report quantities may include L1-SRS-RSRP, L1-CLI-RSSI, or measurement resource indices.

A first UE, which may be an aggressor UE that cause interference to a victim UE, may transmit in an uplink subband of an SBFD symbol. A second UE, which may be the victim UE, may measure an SRS-RSRP measurement resource or a CLI-RSSI measurement resource in the uplink subband of the SBFD symbol. The first UE may transmit in accordance with an uplink timing. The second UE, in order to measure the SRS-RSRP or the CLI-RSSI, may use an offset value to match the uplink timing associated with the first UE. The second UE may apply a constant offset relative to a downlink reference timing, which may allow the second UE to measure the SRS-RSRP or a CLI-RSSI. The second UE may switch from the downlink reference timing to a CLI measurement timing based on the constant offset. The CLI measurement timing for the second UE may be associated with the uplink timing of the first UE. In other examples, a CLI measurement resource (e.g., an SRS-RSRP measurement resource or a CLI-RSSI measurement resource) in a downlink subband of an SBFD symbol. The first UE may measure CLI using the CLI measurement resource based on the downlink timing. However, in some examples, the first UE may be configured with a first CLI measurement resource (e.g., a CLI-RSSI measurement resource) in one or more downlink subbands of a first SBFD symbol and a second CLI measurement resource (e.g., an SRS-RSRP measurement resource) in an uplink subband of a second SBFD symbol that at least partially overlaps in time with the first SBFD symbol (for example, the first SBFD symbol and the second SBFD symbol may be the same SBFD symbol). However, because the first UE may measure CLI using different reference timing for the first CLI measurement resource and the second CLI measurement resource, the first UE may be unable to measure CLI using both the first CLI measurement resource and the second CLI measurement resource in the same SBFD symbol or in at least partially overlapping SBFD symbols. As another example, the first UE may be configured with both a first CLI measurement resource (e.g., a CLI-RSSI measurement resource) and a second CLI measurement resource (e.g., an SRS-RSRP measurement resource) in the uplink subband of the SBFD symbol. If the frequency resources of the first CLI measurement resource and the second CLI measurement resource overlap, the first UE may be unable to measure CLI using both the first CLI measurement resource and the second CLI measurement resource. As a result, the first UE may be unable to measure or transmit a report of CLI measurement information for at least one of the configured CLI measurement resources. This may degrade SBFD performance for a wireless communication network because a network node may not receive the CLI measurement information for at least one of the configured CLI measurement resources, thereby limiting the ability of the network node to mitigate inter-UE CLI in the wireless communication network.

In some examples, a UE that supports SBFD may support downlink reception only in a single downlink subband and uplink transmission only in a single uplink subband. For example, the UE may be unable to simultaneously receive signals across two downlink subbands. For example, a downlink bandwidth part (BWP) configured for the UE during SBFD time intervals (e.g., frames, subframes, slots, or symbols) may not include the two or more downlink subbands configured for SBFD operation. In some examples, a CLI measurement resource, such as a CLI-RSSI measurement resource, may be configured in two (or more) downlink subbands of an SBFD symbol. If the UE does not support simultaneous reception of signals across two downlink subbands of an SBFD symbol, the UE may be unable to measure the full CLI measurement resource within a single SBFD symbol. As a result, the UE may be unable to measure CLI using the CLI measurement parameters. This may degrade SBFD performance for a wireless communication network because a network node may not receive the CLI measurement information for at least one of the configured CLI measurement resources, thereby limiting the ability of the network node to mitigate inter-UE CLI in the wireless communication network. Additionally, or alternatively, one or more measurement parameters (such as a measurement delay or a measurement accuracy) of the CLI measurement may be different than what is expected by a network node, resulting in misalignment between the UE and the network node.

Various aspects relate generally to managing CLI and optimizing measurement configurations in SBFD scenarios within wireless communication networks. Some aspects more specifically relate to configuring CLI measurement resources based on subband and timing considerations, which enables a network node to maintain efficient communication between UEs and the network node. In some aspects, one or more conditions may indicate whether a UE can perform certain CLI measurements or how the UE is to perform the CLI measurements. For example, the UE may perform, in accordance with a condition, one or more CLI measurements using at least one of a first CLI measurement resource or a second CLI measurement resource. The condition may be evaluated based on a first SBFD time interval (e.g., in which the first CLI measurement resource is configured or scheduled) and the second SBFD time interval (e.g., in which the second CLI measurement resource is configured or scheduled). For example, in some aspects, if the condition is satisfied, then the UE may perform CLI measurement using both the first CLI measurement resource and the second CLI measurement resource. If the condition is not satisfied, then the UE may skip performing CLI measurement using at least one of the first CLI measurement resource or the second CLI measurement resource.

In some aspects, the condition may be satisfied based on the first SBFD time interval and the second SBFD time interval not overlapping in the time domain. For example, the UE may not expect to be configured with a first CLI measurement resource (such as a CLI-RSSI measurement resource) in one or more downlink subbands and a second CLI measurement resource (such as an SRS-RSRP measurement resource) in the same SBFD time interval (e.g., in the same SBFD symbol). As another example, where the first CLI measurement resource and the second CLI measurement resource are configured in the same uplink subband of at least partially overlapping SBFD time intervals, the condition may be satisfied based on the frequency resources of the first CLI measurement resource and the second CLI measurement resource not overlapping in the time domain. For example, the UE may not expect to be configured with a first CLI measurement resource (such as a CLI-RSSI measurements resource) and a second CLI measurement resource (such as an SRS-RSRP measurement resource) in an uplink subband, on the same symbol, and the same frequency domain resources (for example, the same resource elements or the same resource blocks).

In some aspects, the UE may support a capability for simultaneous reception of a downlink signal in a downlink subband and CLI measurement (for example, L1 SRS-RSRP CLI measurement) in an uplink subband. In such aspects, the condition may be satisfied for at least partially overlapping SBFD time intervals based on the UE supporting the capability. The capability enables the UE to efficiently utilize overlapping SBFD time intervals by simultaneously receiving downlink signals and performing CLI measurements, thereby optimizing resource usage and reducing potential interference without the need for separate time allocations.

Some aspects described herein enable CLI measurement for a CLI measurement resource that is at least partially configured outside of a BWP for the UE. For example, the UE may receive a configuration for a CLI measurement resource (such as a CLI-RSSI measurement resource) that is configured in two or more downlink subbands of an SBFD time interval. However, a downlink BWP for the UE may only include one of the downlink subbands. In such aspects, one or more parameters of CLI measurement information obtained using the CLI measurement resources are based on the first BWP and the one or more subbands. The one or more parameters may include a measurement delay, a measurement accuracy, or another parameter. For example, a measurement delay associated with obtaining the CLI measurement information may be modified (e.g., increased) to enable the UE to measure CLI using the CLI measurement resource across two or more SBFD symbols. As another example, a measurement accuracy associated with obtaining the CLI measurement information may be modified (e.g., decreased) to enable the UE to measure CLI using the CLI measurement resource in a single SBFD time interval with a reduced quantity of measurement samples (e.g., because measurement samples configured in a downlink subband outside of the downlink BWP may not be measured by the UE). As another example, the UE may switch to a different BWP to perform one or more CLI measurements using the CLI measurement resource.

Particular aspects of the subject matter described in this disclosure can be implemented to realize one or more of the following advantages. By implementing the described CLI measurement configurations, the techniques can be used to enhance measurement accuracy and reduce interference in SBFD scenarios. The coordination between network configurations and UE capabilities enables adaptive resource management, ensuring that UEs can perform accurate CLI measurements without compromising network performance. For example, by the UE performing one or more CLI measurements in accordance with one or more conditions described herein, a likelihood may be improved that the UE is enabled to perform the CLI measurements in the manner configured by a network node. This may improve the reliability of the CLI measurements and improve synchronization between the UE and the network node for the manner in which the UE is to perform the CLI measurements. In this way, the techniques may enable more effective management of CLI, enabling optimized communication performance and resource allocation in TDD networks employing SBFD.

This disclosure may be readily utilized as a basis for modifying or designing other structures for carrying out the same purposes of the present disclosure. Such equivalent constructions do not depart from the scope of the appended claims. Characteristics of the example concepts disclosed herein, both their organization and method of operation, together with associated example advantages, are described in the following description and in connection with the accompanying figures. Each of the figures is provided for the purposes of illustration and description, and not as a definition of the limits of the claims.

While aspects are described in the present disclosure by illustration to some examples, those skilled in the art understand that such aspects may be implemented in many different arrangements and scenarios. Techniques described herein may be implemented using different platform types, devices, systems, shapes, sizes, or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence devices). Aspects may be implemented in chip-level components, modular components, non-modular components, non-chip-level components, device-level components, or system-level components. Devices incorporating described example aspects and example features may include additional example components and example features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, or summers). Aspects described herein may be practiced in a wide variety of devices, components, systems, distributed arrangements, or end-user devices of varying size, shape, and constitution.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, SBFD), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

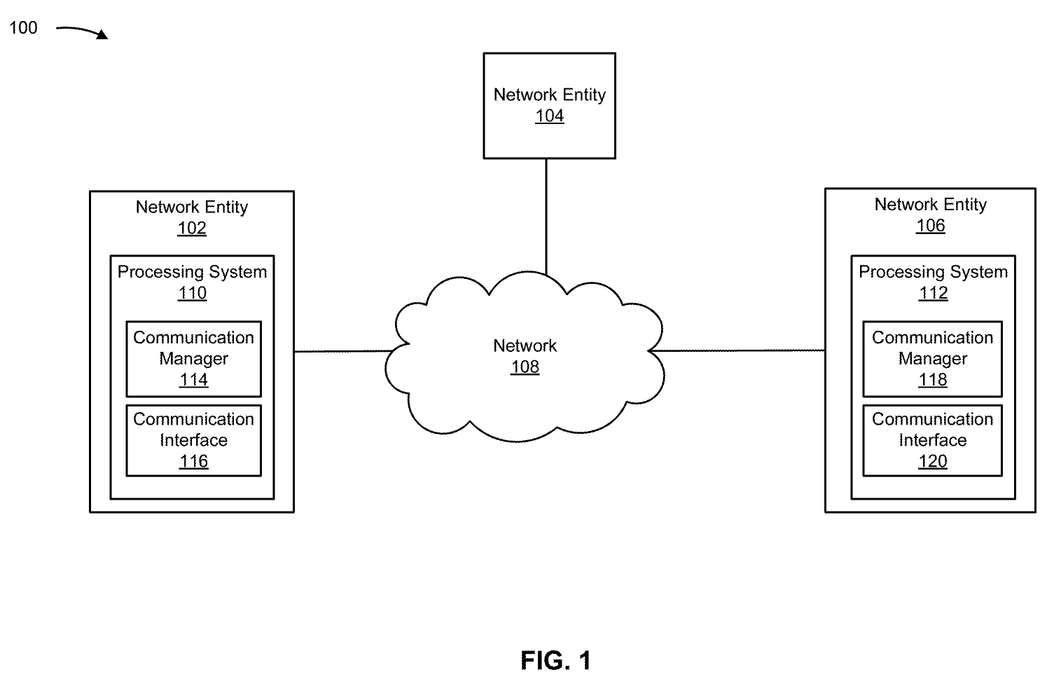

FIG. 1 is a diagram illustrating an example environment 100 in which apparatuses or methods described herein may be implemented. As shown in FIG. 1, the environment 100 may include a network entity 102, a network entity 104, and a network entity 106, that may communicate with one another via a network 108. The network entities 102, 104, and 106, may be dispersed throughout the network 108, and each network entity 102, 104, and 106 may be stationary or mobile. The network 108 may include wired communication connections, wireless communication connections, or a combination of wired and wireless communication connections.

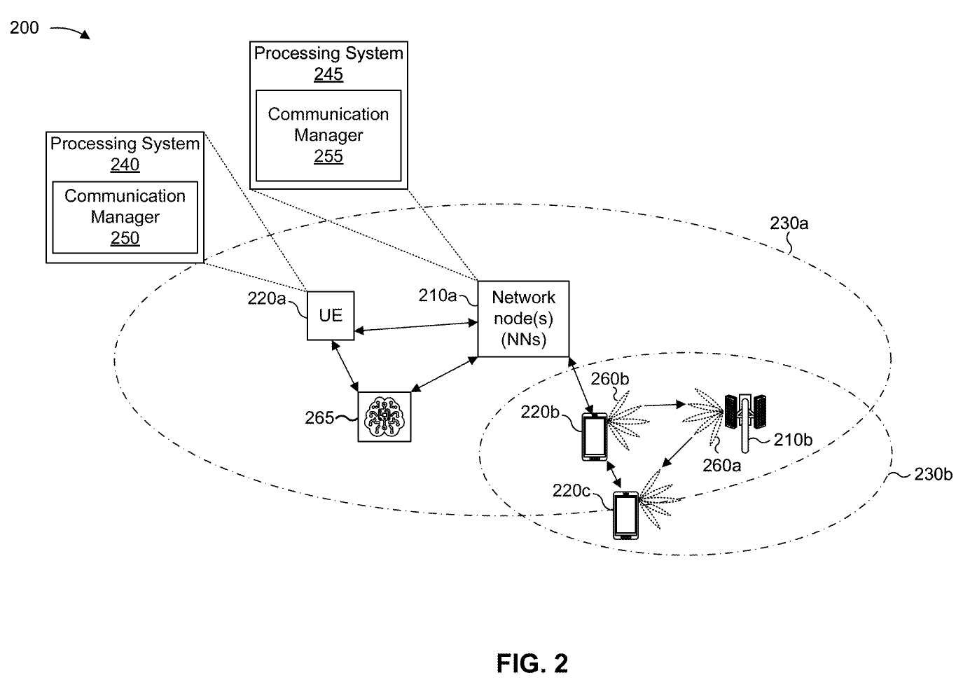

The network 108 may include, for example, a cellular network (e.g., a Long-Term Evolution (LTE) network, a code division multiple access (CDMA) network, a 4G network, a 5G network, a 6G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, or a combination of these or other types of networks. The network 108 may include a wireless communication network 200, described in connection with FIG. 2.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a RedCap device, an enhanced reduced capability (eRedCap) device, an ambient IoT device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in or currently operating in the network. Rather, a network entity may be any entity that is capable of communicating or operating in the network. A network entity may include a network node 210 or a UE 220, described in more detail in connection with FIG. 2.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, “first network entity” may refer to a first UE, a first base station, a first apparatus, a first device, a first computing system, a first set of one or more one or more components, a first processing entity, or the like configured to receive the information; and “second network entity” may refer to a second UE, a second base station, a second apparatus, a second device, a second computing system, a second set of one or more components, or a second processing entity, among other examples.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity 102 may include a processing system 110. Similarly, the network entity 106 may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. A processing system (which may include the processing system 110 and the processing system 112) is described in more detail in connection with FIG. 2, such as in connection with processing system 240 and processing system 245.

As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, or a third component configured to provide the output information to other systems or components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a processing system may include at least one memory, at least one communication interface, or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, or a third component configured to output the one or more outputs to one or more other components. In this example, the first component may be a communication interface (e.g., a first communication interface), the second component may be at least one processor (e.g., that is coupled to the communication interface or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

For example, as shown in FIG. 1, the processing system 110 may include a (e.g., one or more) communication manager 114 and one or more communication interfaces 116. The communication manager 114 may be configured to perform one or more communication tasks as described herein. In some aspects, the communication manager 114 may direct the communication interface 120 or the processing system 110 to perform one or more communication tasks as described herein. Similarly, the processing system 112 may include a (e.g., one or more) communication manager 118 and one or more communication interfaces 120. The communication manager 118 may be configured to perform one or more communication tasks as described herein. In some aspects, the processing system 112 or the communication manager 118 may direct the communication interface 120 to perform one or more communication tasks as described herein. Although depicted, for clarity of description, with reference only to the network entities 102 and 104, any one or more of the network entities 102, 104, and 106 also may include a communication manager and a communication interface.

As used herein, “communication interface” refers to an interface that enables communication (e.g., wireless communication, wired communication, or a combination thereof) between a first network entity and a second network entity. A communication interface may include electronic circuitry that enables a network entity to transmit, receive, or otherwise perform the communication. A communication interface may be, be similar to, include, or be included in one or more components that are configured to enable communication between the first network entity and the second network entity. For example, a communication interface may include a transmission component, a reception component, or a transceiver, among other examples. For example, a communication interface may include one or more transceivers, one or more receivers, or one or more transmitters configured to communicate with other devices, such as via a wired connection, a wireless connection, or a combination of wired and wireless connections. In some examples, a communication interface may include one or more RF components, an RF front end, one or more antennas, one or more transmit or receive processors, a demodulation component, or a modulation component, among other examples.

A communication interface may include a transmission component or a reception component. For example, a communication interface may include a transceiver or one or more separate receivers or transmitters that enable a network entity to communicate with other devices, such as via a wired connection, a wireless connection, or a combination of wired and wireless connections. In some examples, a communication interface may include one or more radio frequency reflective elements or one or more radio frequency refractive elements. The communication interface may enable the network entity to receive information from another apparatus or provide information to another apparatus. In some examples, the communication interface may include an Ethernet interface, an optical interface, a coaxial interface, an infrared interface, an RF interface, a universal serial bus (USB) interface, a Wi-Fi interface, a cellular network interface, a wireless modem, an inter-integrated circuit (I²C), or a serial peripheral interface (SPI), among other examples.

As described herein, a network entity (e.g., the network entity 102 or the network entity 106) may be configured to perform one or more operations. Reference to a network entity being configured to perform one or more operations may refer to a processing system of the network entity being configured to perform the one or more operations or the processing system being configured to cause one or more components of the network entity to perform the one or more operations. For example, reference to the processing system being configured to perform one or more operations may refer to one or more components (or subcomponents) of the processing system performing the one or more operations. For example, the one or more components of the processing system may include at least one memory, at least one processor, or at least one communication interface, among other examples, that are configured to perform one or more (or all) of the one or more operations, or any combination thereof. Where reference is made to the network entity or the processing system being configured to perform operations, the network entity or the processing system may be configured to cause one component to perform all operations, or to cause more than one component to collectively perform the operations. When the network entity or the processing system is configured to cause more than one component to collectively perform the operations, each operation need not be performed by each of those components (e.g., different operations may be performed by different components) or each operation need not be performed in whole by only one component (e.g., different components may perform different sub-functions of an operation).

As described in more detail elsewhere herein, the network entity 102 may (e.g., the processing system 110 may, or the processing system 110 may cause the communication manager 114 or the communication interface 116 to) receive first information indicating that a first CLI measurement resource is to occur in a first subband of a first SBFD time interval; receive second information indicating that a second CLI measurement resource is to occur in a second subband of a second SBFD time interval; and perform , in accordance with a condition, one or more CLI measurements using at least one of the first CLI measurement resource or the second CLI measurement resource, wherein the condition is evaluated based on the first SBFD time interval and the second SBFD time interval. Additionally, or alternatively, the network entity 102 may (e.g., the processing system 110 may, or the processing system 110 may cause the communication manager 114 or the communication interface 116 to) receive first information indicating a first BWP; receive second information indicating that a CLI measurement resource is to occur in one or more subbands of a first SBFD time interval; perform, using the CLI measurement resource, one or more CLI measurements to obtain CLI measurement information, wherein one or more parameters of the CLI measurement information are based on the first BWP and the one or more subbands; and transmit third information indicating the CLI measurement information Additionally, or alternatively, the network entity 102 or the communication manager 114 may perform one or more other operations described herein.

As described in more detail elsewhere herein, the network entity 106 may (e.g., the processing system 112 may, or the processing system 112 may cause the communication manager 118 or the communication interface 120 to) transmit first information, for a second network entity, indicating that a first CLI measurement resource is to occur in a first subband of a first SBFD time interval; and transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval. Additionally, or alternatively, the network entity 106 may (e.g., the processing system 112 may, or the processing system 112 may cause the communication manager 118 or the communication interface 120 to) transmit first information indicating a first BWP; transmit second information indicating that a CLI measurement resource is to occur in one or more subbands of a first SBFD time interval; and receive third information indicating CLI measurement information, wherein one or more parameters of the CLI measurement information are based on the first BWP and the one or more subbands. Additionally, or alternatively, the network entity 106 or the communication manager 118 may perform one or more other operations described herein.

The number and arrangement of entities shown in FIG. 1 are provided as one or more examples. In practice, there may be additional network entities or networks, fewer network entities or networks, different network entities or networks, or differently arranged network entities or networks than those shown in FIG. 1. Furthermore, the network entity 102, 104, and 106 may be implemented using a single apparatus or multiple apparatuses.

FIG. 2 is a diagram illustrating an example of a wireless communication network 200. The wireless communication network 200 may be or may include elements of a 5G network or a 6G network, among other examples. The wireless communication network 200 may include multiple network nodes 210. For example, in FIG. 2, the wireless communication network 200 includes multiple network nodes 210, including a network node 210a and a network node 210b (each of which also may be referred to herein simply as a “network node 210”). The network nodes 210 may support communications with multiple UEs 220. For example, in FIG. 2, the network nodes 210 support communication with a UE 220a, a UE 220b, and a UE 220c (each of which also may be referred to herein simply as a “UE 220”). In some examples, a UE 220 also may communicate with other UEs 220 and a network node 210 also may communicate with a core network and with other network nodes 210. A network node 210 and a UE 220 may be examples of a network entity described herein, such as the network entity 102, the network entity 104, or the network entity 106.

The network nodes 210 and the UEs 220 of the wireless communication network 200 communicate using the electromagnetic spectrum, which may be subdivided into various licensed or unlicensed operating bands, frequency ranges, component carriers, or channels that define associated frequencies available for communications. In some examples, each of the network nodes 210 and the UEs 220 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 210 or a UE 220 may include one or more devices, components, or systems that enable communication with other devices, components, or systems of the wireless communication network 200. For example, a UE 220 and a network node 210 may each include one or more chips, system-on-chips (SoCs), chipsets, packages, or devices that individually or collectively constitute or comprise a processing system. As shown in FIG. 2, each UE 220 includes a processing system 240 and each network node 210 includes a processing system 245. A processing system (for example, the processing system 240 or the processing system 245) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 240 and the processing system 245 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 240 and the processing system 245 may each include or be coupled with one or more modems (such as a cellular (for example, a 5G or 6G compliant) modem). In some examples, one or more processors of the processing system 240 or the processing system 245 may include or implement one or more of the modems. The processing system 240 and the processing system 245 also may include or be coupled with multiple radios (collectively “the radio”), multiple RF chains, or multiple transceivers, each of which may in turn be coupled with one or more of multiple antennas. In some examples, one or more processors of the processing system 240 or the processing system 245 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 240 or by the processing system 245).

A network node 210 and a UE 220 may each include one or multiple antennas or antenna arrays. Typical network nodes 210 and UEs 220 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 210 and the UE 220.

A network node 210 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 210 may be implemented as a single physical node (for example, a single physical structure) or may be implemented as two or more physical nodes (for example, two or more distinct physical structures). For example, a network node 210 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 210 may be an aggregated network node having an aggregated architecture, meaning that the network node 210 may implement a full radio protocol stack that is physically and logically integrated within a single physical structure in the wireless communication network 200. For example, an aggregated network node 210 may include a single standalone base station or a single TRP that operates with a full radio protocol stack to enable or facilitate communication between a UE 220 and a core network of the wireless communication network 200.

Alternatively, and as also shown, a network node 210 may be a disaggregated network node 210 (sometimes referred to as a disaggregated base station), having a disaggregated architecture, meaning that the network node 210 may operate with a radio protocol stack that is physically distributed or logically distributed among two or more nodes in the same geographic location or in different geographic locations. In some deployments, disaggregated network nodes 210 may be used in an IAB network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 210 of the wireless communication network 200 may include one or more CUs, one or more DUs, and one or more RUs. A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 220. In some examples, a single network node 210 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 200 may be a heterogeneous network that includes network nodes 210 of various types. Different types of network nodes 210 may generally operate on the same or different operating bands, transmit at different power levels, or serve different coverage areas, each of which may be referred to as or associated with a particular cell 230 (for example, a cell 230a and a cell 230b).

The UEs 220 may be physically dispersed throughout the coverage area of the wireless communication network 200, and each UE 220 may be stationary or mobile. A UE 220 may be, may include, or also may be referred to as an access terminal, a mobile station, a client device, or a subscriber unit. A UE 220 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 200.

Some UEs 220 may be classified according to different categories in association with different complexities or different capabilities. UEs 220 in a first category may be associated with relatively low complexity or cost such as NB-IoT devices or eMTC UEs. UEs 220 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 200. A third category of UEs 220 may have mid-tier complexity or capabilities (for example, capabilities between that of the UEs 220 of the first category and the UEs 220 of the second category). A UE 220 of the third category may be referred to as a reduced capability UE (“RedCap UE”), a mid-tier UE, an NR-Light UE, or an NR-Lite UE, among other examples.

In some examples, a network node 210 may be, may include, or may operate as an RU, a TRP, or a base station that communicates with one or more UEs 220 via a radio access link (which may be referred to as a “Uu” link). The radio access link may include a downlink and an uplink. “Downlink” (or “DL”) refers to a communication direction from a network node 210 to a UE 220, and “uplink” (or “UL”) refers to a communication direction from a UE 220 to a network node 210. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 220 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 210 transmitting a downlink control information (DCI) configuration to the one or more UEs 220) or reconfigured (for example, in real-time or near-real-time) according to changing network conditions in the wireless communication network 200 or specific requirements of one or more UEs 220. An active BWP defines the operating bandwidth of the UE 220 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 210 to a UE 220. DCI generally contains the information the UE 220 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 220) from a network node 210 to a UE 220. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 220 to a network node 210. An uplink data channel may be used to transmit uplink data (for example, user data associated with a UE 220) from a UE 220 to a network node 210. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 210), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, an L1-RSRP parameter, an RSSI parameter, a reference signal received quality (RSRQ) parameter, among other examples) which can be used for beam management, among other examples. Each PUSCH may carry one or more TBs of data.

The information (for example, data, control information, or reference signal information) transmitted by a network node 210 to a UE 220, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 210 or UE 220 over a wireless communication channel. In some examples, the network node 210 or the UE 220 (for example, using the processing system 245 or the processing system 240, respectively) may select an MCS (for example, an order of quadrature amplitude modulation (QAM), such as 64-QAM, 128-QAM, or 256-QAM, among other examples) for a downlink signal or an uplink signal. For example, the network node 210 may select an MCS for a downlink signal in accordance with UCI received from the UE 220 or may transmit, to the UE 220, an indication of an MCS to be applied for an uplink signal.

A network node 210 or a UE 220 (such as by using the processing system 245 or the processing system 240, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 210 or the UE 220 (for example, using the processing system 245 or the processing system 240, respectively, or one or more coupled encoders or modems) may perform a channel coding operation or a forward error correction (FEC) operation to control errors in transmitted information. For example, the network node 210 or the UE 220 may perform an encoding operation to generate encoded information (such as by selectively introducing redundancy into the information, typically using an error correction code (ECC), such as a polar code or a low-density parity-check (LDPC) code). The network node 210 or the UE 220 (for example, using the processing system 245 or one or more modems) may further perform spatial processing (for example, precoding) on the encoded information to generate one or more processed or precoded signals for downlink or uplink transmission, respectively. In some examples, the network node 210a or the UE 210a may perform codebook-based precoding or non-codebook-based precoding. Codebook-based precoding may involve selecting a precoder (for example, a precoding matrix) using a codebook. For example, the network node 210a may provide precoding information indicating which precoder, defined by the codebook, is to be used by the UE 210a. Non-codebook-based precoding may involve selecting or deriving a precoder based on, or otherwise associated with, one or more downlink or uplink signal measurements. The network node 210aor the UE 210amay transmit the processed downlink or uplink signals, respectively, via one or more antennas.

The network node 210a or the UE 220a may receive uplink signals or downlink signals, respectively, via one or more antennas. The network node 210a or the UE 210a(for example, using the processing system 245 or the processing system 240, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 210 or the UE 220 via the downlink or uplink signals. The network node 210aor the UE 210a(for example, using the processing system 245 or the processing system 240, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 220 and a network node 210 may perform MIMO communication. MIMO communication generally refers to transmitting or receiving multiple signals (such as multiple layers or multiple data streams) simultaneously over the same time and frequency resources. A network node 210 or a UE 220 may communicate using single-user MIMO or multi-user MIMO (MU-MIMO), the latter of which being used by a network node 210 to simultaneously transmit signals to multiple UEs 220. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 210 may generate one or more beams 210a, and a UE 220 may generate one or more beams 210b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 210 or a UE 220 may implement massive MIMO, which may be associated with an increased (for example, “massive”) quantity of antennas at the network node 210 or at the UE 220, such as in a network implementing mmWave technology, which enables more precise beamforming or reduced interference. In some examples, the wireless communication network 200 may implement multi-TRP (mTRP) operation (including redundant transmission or reception on multiple TRPs) or non-coherent joint transmission (NC-JT).

The network node 210 and the UE 220 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 210 transmitting signals (for example, SSBs or other signals) via respective beams (for example, of the beams 260 of the network node 210) and the UE 220 receiving and measuring the signal(s) via respective beams of multiple beams (for example, from the beams 260 of the UE 220) to identify a best beam (or beam pair) for communication between the UE 220 and the network node 210. A beam refinement operation may involve a first device (for example, the UE 220 or the network node 210) transmitting signal(s) via a subset of beams (for example, identified based on, or otherwise associated with, measurements reported as part of one or more other beam management operations). A second device (for example, the network node 210 or the UE 220) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 265 (for example, one or more network nodes 210, one or more UEs 220, one or more servers, or one or more components of a cloud computing network, among other examples). For example, in a deployment in which AI/ML functionality is performed independently at a device 265, sometimes referred to as “overlay AI/ML,” the AI/ML model (or an instance or portion of the AI/ML model) may be deployed at a UE 220 (for example, by the processing system 240), a network node 210 (for example, by the processing system 245), one or more servers, or one or more components of a cloud computing network, among other examples. Additionally, or alternatively, in a deployment where AI/ML functionality is coordinated between different devices 265, sometimes referred to as “coordinated AI/ML,” or performed at all device and network layers, sometimes referred to as “native AI/ML,” the AI/ML model (or an instance of the AI/ML model) may be deployed at multiple devices 265 (for example, a first portion of the AI/ML model may be deployed at a UE 220 and a second portion of the AI/ML model may be deployed at a network node 210). In other examples of coordinated AI/ML or native AI/ML, a first AI/ML model may be deployed at a UE 220 and a second AI/ML model may be deployed at a network node 210. The AI/ML model(s) may be configured to enhance various aspects of the wireless communication network 200 (for example, to increase privacy, reliability, or efficient use of network bandwidth, or to reduce latency, among other examples). For example, the AI/ML model(s) may be trained to identify patterns or relationships in data corresponding to the wireless communication network 200, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 220, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a network entity (e.g., a UE 220) may include a communication manager 250. As described in more detail elsewhere herein, the communication manager 250 may receive first information indicating that a first CLI measurement resource is to occur in a first subband of a first SBFD time interval; receive second information indicating that a second CLI measurement resource is to occur in a second subband of a second SBFD time interval; and perform, in accordance with a condition, one or more CLI measurements using at least one of the first CLI measurement resource or the second CLI measurement resource, wherein the condition is evaluated based on the first SBFD time interval and the second SBFD time interval. Additionally, or alternatively, the communication manager 250 may receive first information indicating a first BWP; receive second information indicating that a CLI measurement resource is to occur in one or more subbands of a first SBFD time interval; perform, using the CLI measurement resource, one or more CLI measurements to obtain CLI measurement information, wherein one or more parameters of the CLI measurement information are based on the first BWP and the one or more subbands; and transmit third information indicating the CLI measurement information Additionally, or alternatively, the communication manager 250 may perform one or more other operations described herein.

In some aspects, a first network entity (e.g., a network node 210) may include a communication manager 255. As described in more detail elsewhere herein, the communication manager 255 may transmit first information, for a second network entity, indicating that a first CLI measurement resource is to occur in a first subband of a first SBFD time interval; and transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval. Additionally, or alternatively, the communication manager 255 may transmit first information indicating a first BWP; transmit second information indicating that a CLI measurement resource is to occur in one or more subbands of a first SBFD time interval; and receive third information indicating CLI measurement information, wherein one or more parameters of the CLI measurement information are based on the first BWP and the one or more subbands. Additionally, or alternatively, the communication manager 255 may perform one or more other operations described herein.

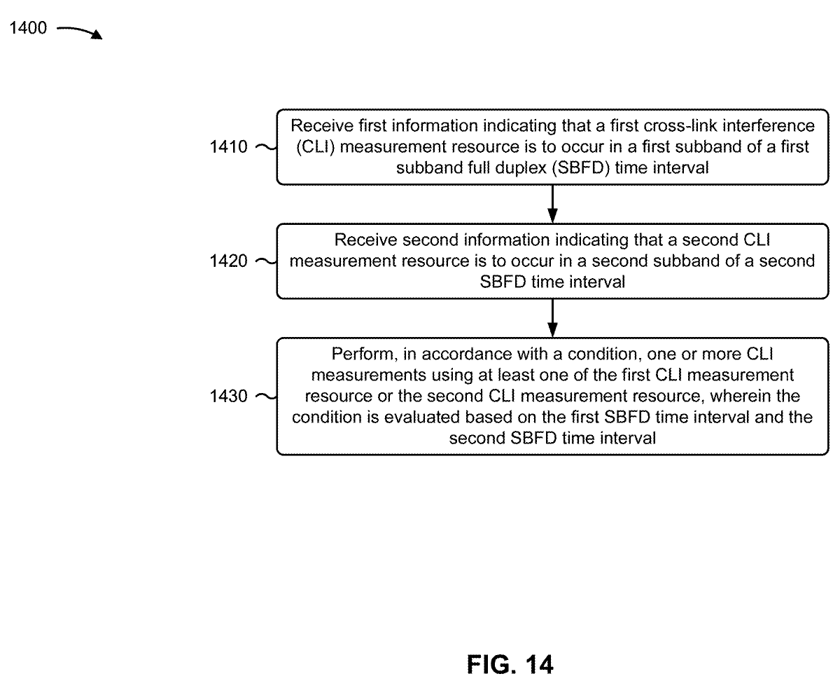

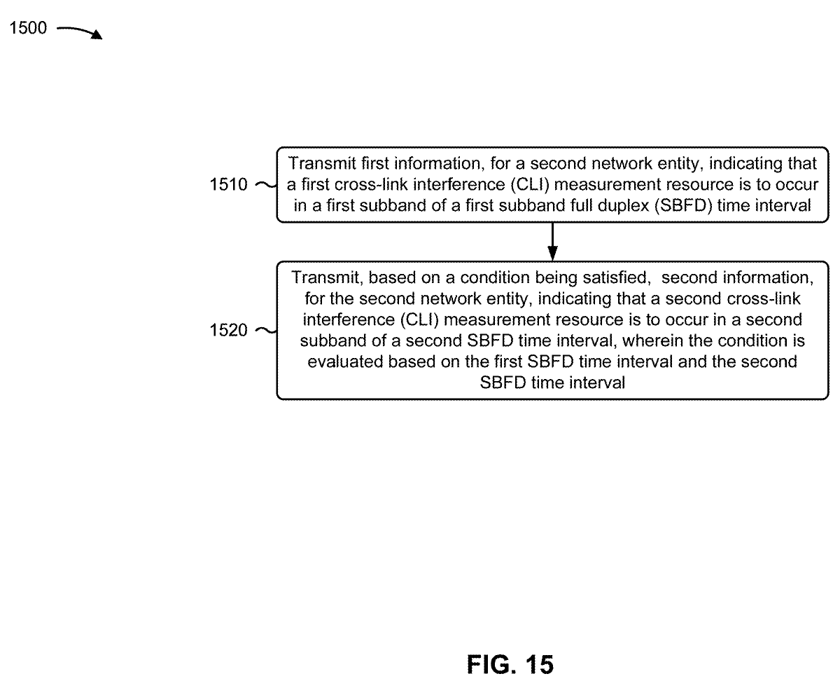

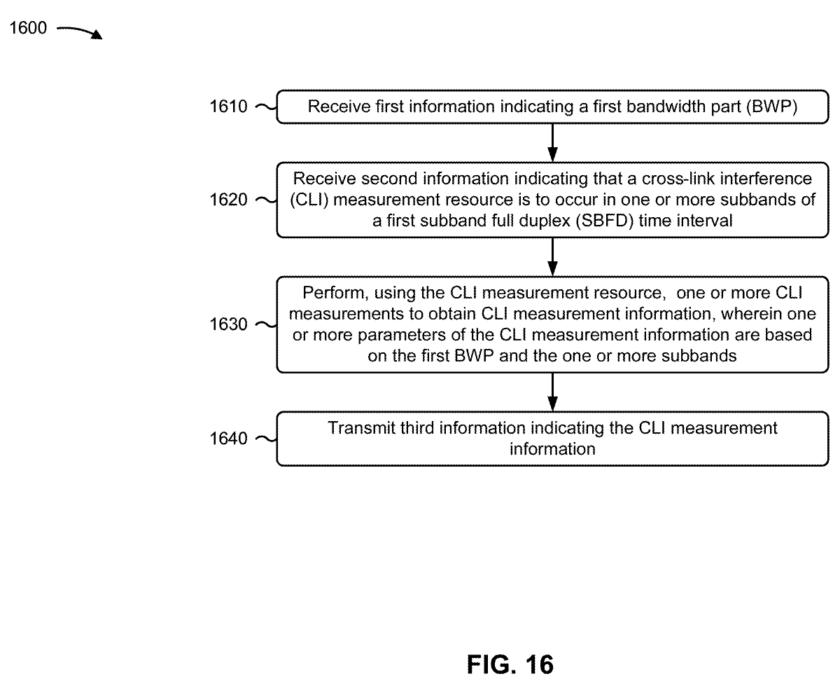

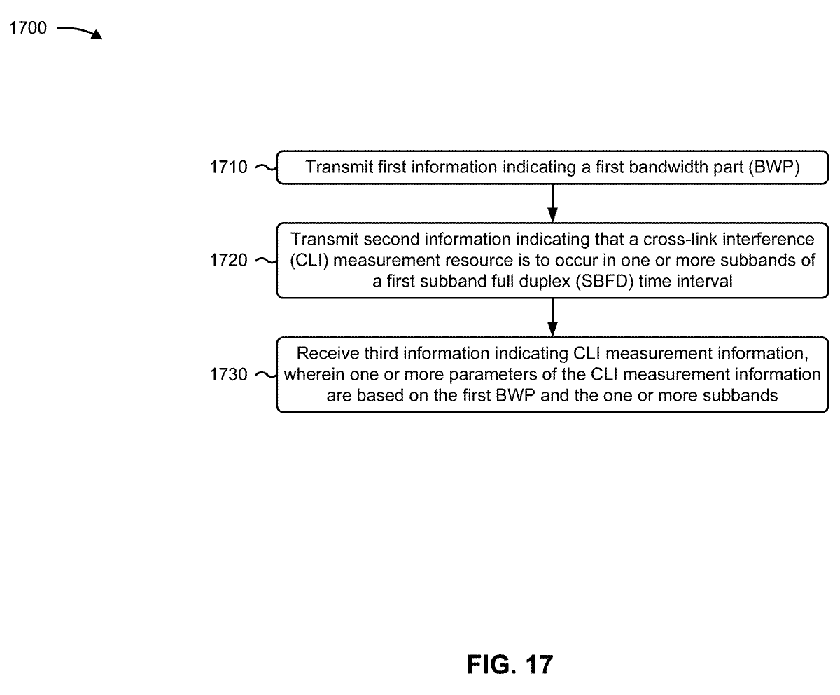

The network entity 102, the processing system 110 of the network entity 102, the network entity 106, the processing system 112 of the network entity 106, the network node 210, the processing system 245 of the network node 210, the UE 220, the processing system 240 of the UE 220, or any other component(s) of FIGS. 1-2 may implement one or more techniques or perform one or more operations associated with CLI measurement conditions, as described in more detail elsewhere herein. For example, the processing system 110 of the network entity 102, the processing system 112 of the network entity 106, the processing system 245 of the network node 210, or the processing system 240 of the UE 220 may perform or direct operations of, for example, process 1400 of FIG. 14, process 1500 of FIG. 15, process 1600 of FIG. 16, process 1700 of FIG. 17, or other processes as described herein (alone or in conjunction with one or more other processors). Memory of the network node 210 may store data and program code (or instructions) for the network node 210. In some examples, the memory of the network node 210 may store data relating to a UE 220, such as RRC state information or a UE context. Memory of a UE 220 may store data and program code (or instructions) for the UE 220, such as context information. In some examples, the memory of the UE 220 or the memory of the network node 210 may include a non-transitory computer-readable medium storing a set of instructions for wireless communication. For example, the set of instructions, when executed by one or more processors (for example, of the processing system 110, the processing system 112, the processing system 245, or the processing system 240) of the network entity 102, the network entity 106, the network node 210, or the UE 220 may cause the one or more processors to perform process 1400 of FIG. 14, process 1500 of FIG. 15, process 1600 of FIG. 16, process 1700 of FIG. 17, or other processes as described herein. In some examples, executing instructions may include running the instructions, converting the instructions, compiling the instructions, or interpreting the instructions, among other examples.

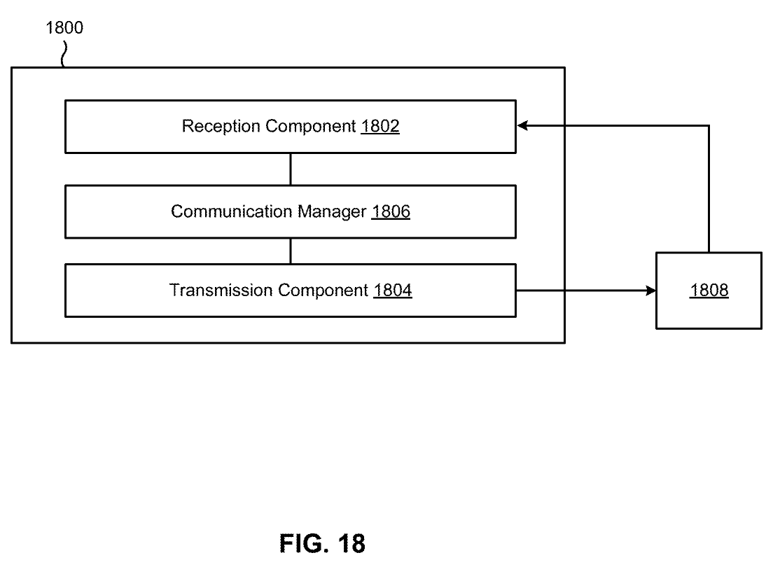

In some aspects, a network entity includes means for receiving first information indicating that a first CLI measurement resource is to occur in a first subband of a first SBFD time interval; means for receiving second information indicating that a second CLI measurement resource is to occur in a second subband of a second SBFD time interval; or means for performing, in accordance with a condition, one or more CLI measurements using at least one of the first CLI measurement resource or the second CLI measurement resource, wherein the condition is evaluated based on the first SBFD time interval and the second SBFD time interval. Additionally, or alternatively, the network entity includes means for receiving first information indicating a first BWP; means for receiving second information indicating that a CLI measurement resource is to occur in one or more subbands of a first SBFD time interval; means for performing, using the CLI measurement resource, one or more CLI measurements to obtain CLI measurement information, wherein one or more parameters of the CLI measurement information are based on the first BWP and the one or more subbands; or means for transmitting third information indicating the CLI measurement information. In some aspects, the means for the first network entity to perform operations described herein may include, for example, one or more of communication manager 250, processing system 240, processing system 110, communication manager 114, communication interface 116, processing system 112, communication manager 118, communication interface 120, a radio, one or more RF chains, one or more transceivers, one or more antennas, one or more modems, a reception component (for example, reception component 1802 depicted and described in connection with FIG. 18) or a transmission component (for example, transmission component 1804 depicted and described in connection with FIG. 18), among other examples.

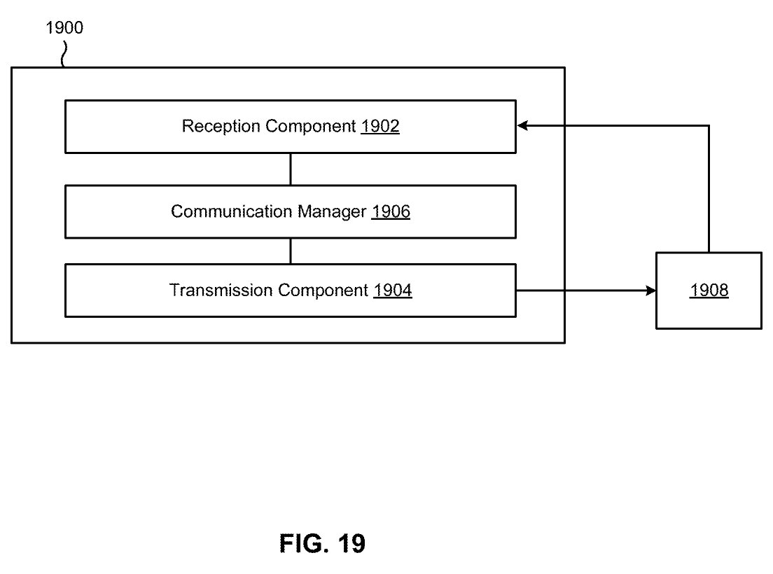

In some aspects, the network entity includes means for transmitting first information, for a second network entity, indicating that a first CLI measurement resource is to occur in a first subband of a first SBFD time interval; or means for transmitting, based on a condition being satisfied, second information, for the second network entity, indicating that a second CLI measurement resource is to occur in a second subband of a second SBFD time interval, wherein the condition is evaluated based on the first SBFD time interval and the second SBFD time interval. Additionally, or alternatively, the network entity includes means for transmitting first information indicating a first BWP; means for transmitting second information indicating that a CLI measurement resource is to occur in one or more subbands of a first SBFD time interval; or means for receiving third information indicating CLI measurement information, wherein one or more parameters of the CLI measurement information are based on the first BWP and the one or more subbands. In some aspects, the means for the first network entity to perform operations described herein may include, for example, one or more of communication manager 255, processing system 245, processing system 110, communication manager 114, communication interface 116, processing system 112, communication manager 118, communication interface 120, a radio, one or more RF chains, one or more transceivers, one or more antennas, one or more modems, a reception component (for example, reception component 1902 depicted and described in connection with FIG. 19), or a transmission component (for example, transmission component 1904 depicted and described in connection with FIG. 19), among other examples.

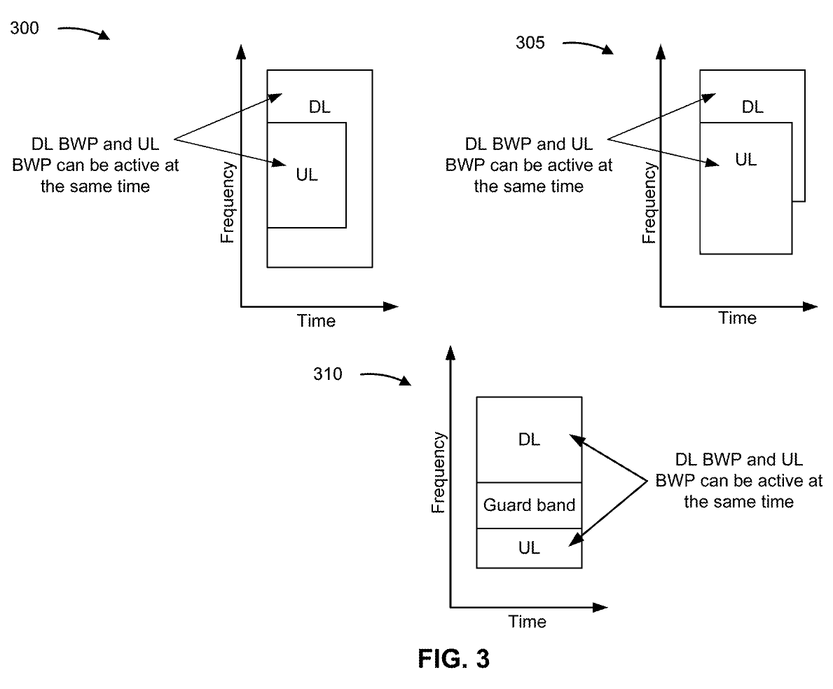

FIG. 3 is a diagram illustrating examples 300, 305, and 310 of full-duplex communication in a wireless network. “Full-duplex communication” in a wireless network refers to simultaneous bi-directional communication between devices in the wireless network. For example, a network node 210 operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

As shown in FIG. 3, examples 300 and 305 show examples of in-band full-duplex (IBFD) communication. In IBFD, a network node 210 may receive an uplink communication from a UE 220 and transmit a downlink communication to a UE 220 on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “subband frequency division duplex” or “flexible duplex.” In SBFD, a network node 210 may receive an uplink communication from a UE 220 and transmit a downlink communication to a UE 220 at the same time, but on different frequency resources. For example, the different frequency resources may be subbands of a frequency band, such as a time division duplexing band. In this case, the frequency resources used for downlink communication may be separated from the frequency resources used for uplink communication, in the frequency domain, by a guard band.

As indicated above, FIG. 3 is provided as an example. Other examples may differ from what is described with regard to FIG. 3.

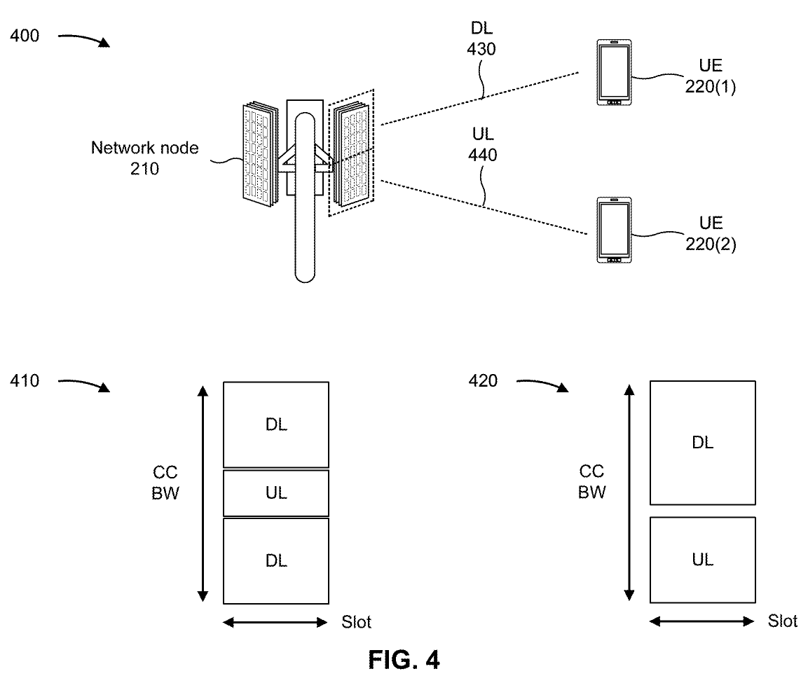

FIG. 4 is a diagram illustrating examples 400, 410, and 420 associated with SBFD operation at a network node 210.

In example 400, the network node 210 may operate in a full duplex mode (for example, an SBFD mode) to simultaneously transmit a downlink signal 430 (“DL”) to the UE 220(1) and receive an uplink signal 440 (“UL”) from the UE 220(2) on a subband basis on the same slot. For example, the network node 210 may communicate in SBFD mode with UEs 220(1) and 220(2) using TDD carrier, or the communication may be intra-band-carrier-aggregation-based. In example 410, two downlink subbands and one uplink subband may be configured for operation in SBFD mode. Additionally or alternatively, in example 420, one downlink subband and one uplink subband may be configured for operation in SBFD mode. For example, a time interval (e.g., a slot, a subframe, a mini-slot, or an OFDM symbol) may be configured as a downlink time interval, an uplink time interval, or a flexible time interval, such as via a TDD configuration (e.g., a TDD-UL-DL-ConfigCommon). With an SBFD mode, a network node 210 may configure one or more downlink time intervals or flexible time intervals as SBFD time intervals. An SBFD time interval may include one or more uplink subbands and one or more downlink subbands, such as shown by the example 410 and the example 420. A UE 220 (e.g., an SBFD-aware UE) may be configured to transmit one or more uplink communications in an uplink subband of an SBFD time interval. The UE 220 may be configured to receive one or more downlink communications in a downlink subband of an SBFD time interval.

SBFD may increase uplink duty cycles, which may lead to latency reduction and uplink coverage improvement. For example, SBFD may enable uplink latency savings by allowing the network node 210 to transmit uplink signals in uplink subbands configured in downlink-only slots or flexible slots. Additionally or alternatively, SBFD may enhance one or more of system capacity, resource utilization, or spectrum efficiency. Additionally or alternatively, SBFD may enable flexible and dynamic uplink or downlink resource adaptation in a robust manner according to uplink or downlink traffic.

As indicated above, FIG. 4 is provided as an example. Other examples may differ from what is described with regard to FIG. 4.

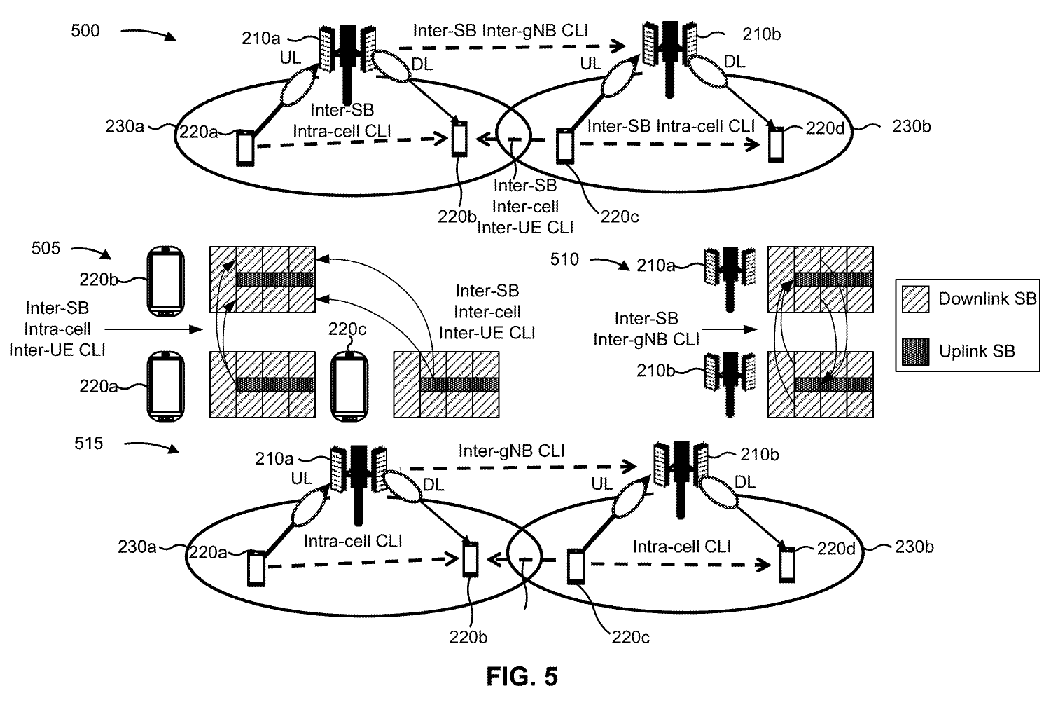

FIG. 5 is a diagram illustrating examples 500, 505, 510, and 515 of CLI.

In SBFD, messages can be transmitted on nearby links at the same time, which can cause CLI. Example 500 shows different types of CLI for SBFD communications, such as inter-SB CLI between subbands, intra-cell CLI within a cell, inter-cell CLI between cells (for example, cells 130a and 130b), inter-UE CLI between UEs (for example, UEs 220a-220d), and inter-gNB CLI between network nodes 210a and 210b. Example 505 shows how inter-SB inter-UE CLI can arise. For example, inter-SB intra-cell inter-UE CLI may occur when the UE 220a transmits an uplink communication in an uplink subband that interferes with the UE 220b via one or more downlink subbands. Additionally or alternatively, inter-SB inter-cell inter-UE CLI may occur when the UE 220c transmits an uplink communication in an uplink subband that interferes with the UE 220b via one or more downlink subbands. Example 510 shows how inter-SB inter-gNB CLI can arise. For example, inter-SB inter-gNB CLI may occur when the network node 210a transmits a downlink communication in one or more downlink subbands that interferes with the network node 210b via an uplink subband. Additionally or alternatively, inter-SB inter-gNB CLI may occur when the network node 210b transmits a downlink communication in one or more downlink subbands that interferes with the network node 210a via an uplink subband. Example 515 shows different types of CLI for partially or fully overlapped full duplex communications, such as intra-cell CLI within a cell, inter-cell CLI between cells (for example, cells 130a and 130b), inter-UE CLI between UEs (for example, UEs 220a-220d), and inter-gNB CLI between network nodes 210a and 210b.

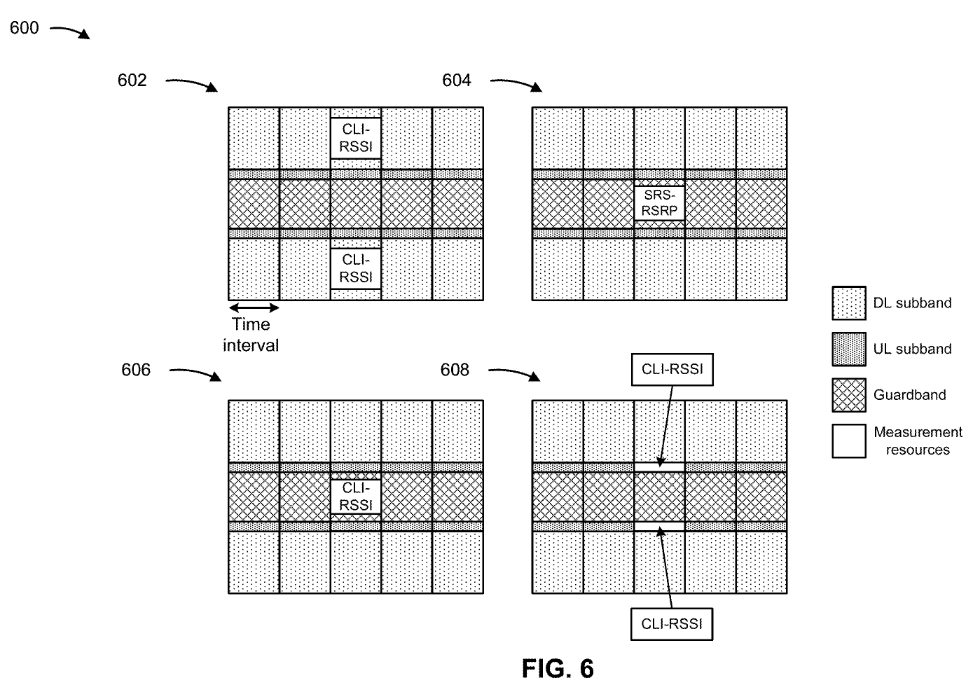

A CLI framework may support L1-based UE-to-UE (for example, inter-UE) CLI measurement and reporting. For example, the UE 220b may use a CLI measurement resource for measuring CLI. In some examples, the CLI measurement resource may be periodic, semi-persistent, or aperiodic. In some examples, the CLI measurement resource may be an SRS-RSRP measurement resource for RSRP measurements of CLI or a CLI-RSSI measurement resource for RSSI measurements of CLI. For example, a UE 220 may receive a CLI measurement configuration (such as an SRS-RSRP-MeasurementResourceSet) containing a set of one or more SRS-RSRP measurement resource(s) (e.g., one or more SRS-RSRP-MeasurementResource information elements (IEs)) for L1 SRS-RSRP measurement. Additionally, or alternatively, the UE 220 may receive a CLI measurement configuration (such as anCLI-RSSI-MeasurementResourceSet) containing a set of one or more CLI-RSSI measurement resource(s) (e.g., one or more CLI-RSSI-MeasurementResource IEs) for L1 CLI-RSSI measurement. In some examples, the UE 220 may be configured to measure an RSSI of CLI within a downlink subband (e.g., via a CLI-RSSI measurement resource), as depicted in a measurement type 602 and FIG. 6. Additionally, or alternatively, the UE 220 may be configured to measure an RSRP of an aggressor UE within an uplink subband (e.g., via an SRS-RSRP measurement resource), as depicted in a measurement type 604 and FIG. 6. Additionally, or alternatively, the UE 220 may be configured to measure RSSI of CLI within an uplink subband (e.g., via a CLI-RSSI measurement resource), as depicted in a measurement type 606 and FIG. 6.

In some examples, the UE 220b may be configured with one or more QCL type D (also referred to as “‘typeD’ QCL,” “QCL type-D,” or “QCL Type-D,” among other examples) assumptions for the CLI measurement resource. QCL type D may involve a spatial receive parameter or beamforming properties of a downlink receive signal. A QCL type-D assumption may include information for a QCL type-D relationship between two beams. In some examples, measurement reporting may be periodic, semi-persistent, or aperiodic.

An (IE CSI-AperiodicTriggerStateList may support aperiodic L1 CLI-RSSI/CLI-SRS-RSRP reporting on PUSCH. In a parameter CSI-AssociatedReportConfigInfo, a list of TCI state(s) with qcl-Type set to ‘typeD’ may be configured. The TCI state(s) may correspond to the resource(s) in a set of CLI measurement resources (for example, periodic, semi-persistent, or aperiodic CLI measurement resources) indicated by CSI-AssociatedReportConfigInfo. In some examples, the list of TCI states may be configured if a parameter unifiedTCI-StateType is configured and the CLI measurement resource(s) are aperiodic. If the list of TCI states is not configured (for example, is absent), then the UE 220b may assume the following for each CLI measurement resource: if the parameter unifiedTCI-StateType is not configured, then, for purposes of performing CLI measurement in FR2, the UE 220b may assume that the configured CLI measurement resources are quasi-co-located with typeD to one of the latest received PDSCH beam or a latest monitored control resource set (CORESET) beam; and if the parameter unifiedTCI-StateType is configured, then the UE 220b may use a QCL type-D assumption that follows QCL information in an indicated downlink-only or joint TCI state.

For aperiodic L1 CLI-RSSI/CLI-SRS-RSRP reporting on PUSCH using a set of periodic CLI measurement resources, the TCI state(s) with QCL typeD for the CLI measurement resources in the periodic CLI measurement resource set may be configured per CLI measurement resource (for example, either for all resources in the set or for none) by a higher-layer parameter. For each periodic CLI measurement resource, this higher-layer parameter may provide a reference to one TCI statein the list of TCI states (for example, one “TCI-State” in “TCI-States”) for providing the QCL source and QCL typeD. If the TCI state is not configured, then the UE QCL assumptions may be default rules. Additionally or alternatively, for aperiodic L1 CLI-RSSI/CLI-SRS-RSRP reporting on PUSCH using a set of semi-persistent CLI measurement resources, the network node 210 may activate or deactivate the configured semi-persistent CLI measurement resource sets by transmitting a semi-persistent CLI measurement resource set activation/deactivation MAC-CE. This MAC-CE may include a TCI state identifier i (IDᵢ) field (where i denotes a CLI measurement resource), which may be used as a typeD QCL source for the CLI measurement resource within the semi-persistent CLI measurement resource set. In some examples, either all TCI state identifier (ID) fields may be present or none may be present. If the TCI state ID field(s) are absent, then the UE QCL assumptions may be default rules.

As indicated above, FIG. 5 is provided as an example. Other examples may differ from what is described with regard to FIG. 5.

FIG. 6 is a diagram illustrating an example 600 of CLI measurements. FIG. 6 depicts different measurement types for CLI measurement, such as a measurement type 602, a measurement type 604, a measurement type 606, and a measurement type 608.

For the measurement type 602, a CLI-RSSI measurement resource may be associated with a first downlink subband and the CLI-RSSI measurement resource may be associated with a second downlink subband. The first downlink subband and the second downlink subband may be associated with a same time interval (e.g., an SBFD slot or the same OFDM symbol). For example, the CLI-RSSI measurement resource may be configured in the first downlink subband and the second downlink subband (or a first CLI-RSSI measurement resource may be configured in the first downlink subband and a second CLI-RSSI measurement resource may be configured in the second downlink subband). For the measurement type 604, a CLI SRS-RSRP measurement resource may be associated with an uplink subband of a time interval (e.g., an SBFD slot or one or more OFDM symbols). For example, an SRS-RSRP measurement resource may be configured in the uplink subband. For the measurement type 606, a CLI-RSSI measurement resource may be associated with an uplink subband of a time interval (e.g., an SBFD slot or one or more OFDM symbols). For example, the CLI-RSSI measurement resource may be configured in the uplink subband. For the measurement type 608, a first CLI-RSSI measurement resource may be associated with a first guard band and a second CLI-RSSI measurement resource may be associated with a second guard band. The first guard band and the second guard band may be associated with a same time interval (e.g., an SBFD slot or one or more OFDM symbols).

In some aspects, a UE may not be configured to perform the measurement type 602 and the measurement type 606 in the same OFDM symbol. Additionally, measurement resources corresponding to the measurement type 602 and the measurement type 606 may not be associated with the same CSI report configuration (e.g., the same CSI-ReportConfig). However, in some cases, the measurement type 602 and the measurement type 604 may be configured for a UE in at least partially overlapping OFDM symbols. Because the UE may apply different timing for the measurement type 602 and the measurement type 604, the UE may be unable to perform both the measurement type 602 and the measurement type 604 in the same OFDM symbol. Additionally, the measurement type 604 and the measurement type 606 may be configured for a UE in at least partially overlapping OFDM symbols. In some aspects, the CLI measurement resource(s) for the measurement type 604 and the measurement type 606 may include at least partially overlapping frequency domain resources (e.g., may include at least one common frequency domain resource). In such examples, the UE may be unable to perform both the measurement type 604 and the measurement type 606 in the same OFDM symbol.

As indicated above, FIG. 6 is provided as an example. Other examples may differ from what is described with regard to FIG. 6.

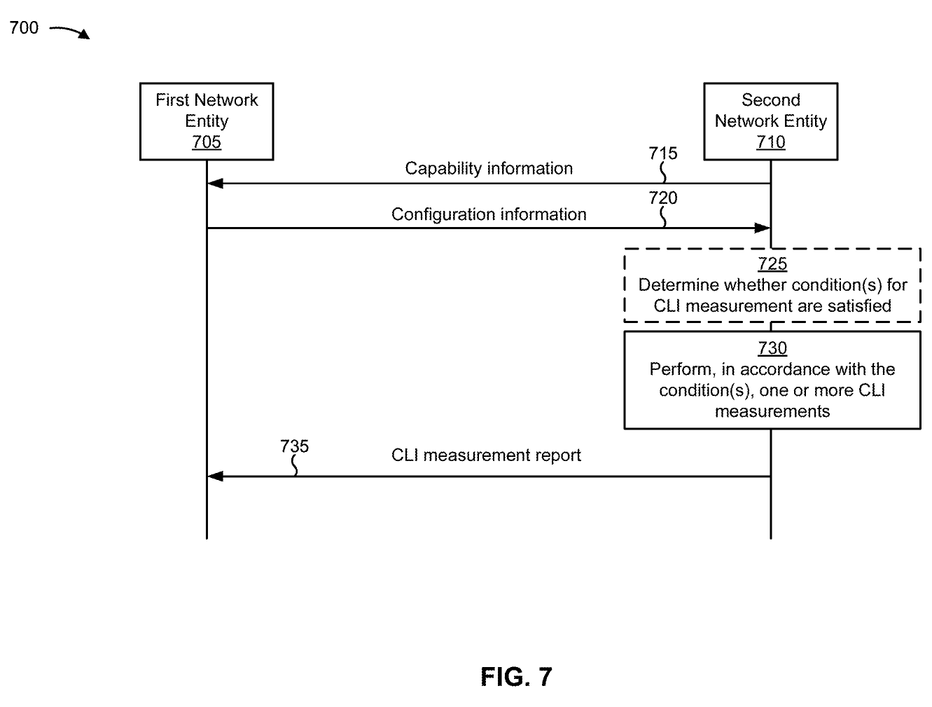

FIG. 7 is a diagram of an example 700 associated with CLI measurement conditions. As shown in FIG. 7, a first network entity 705 (e.g., the network entity 102, the network entity 106, a network node 210, or a UE 220) may communicate with a second network entity 710 (e.g., the network entity 102, the network entity 106, or a UE 220). In some aspects, the first network entity 705 and the second network entity 710 may be part of a wireless network (e.g., the wireless communication network 200). The first network entity 705 and the second network entity 710 may have established a wireless connection prior to operations shown in FIG. 7.

In some aspects, as shown by reference number 715, the second network entity 710 may transmit capability information. The capability information may be included in a capability report. The second network entity 710 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the second network entity 710. The one or more parameters may be indicated via respective IEs included in a capability report.

The capability information may indicate whether the second network entity 710 supports a feature or one or more parameters related to the feature. For example, the capability information may indicate a capability or parameter for supporting SBFD operation. For example, the capability information may indicate that the second network entity 710 is SBFD-aware. As another example, the capability information may indicate a capability or parameter for being configured with an SBFD configuration (e.g., the second network entity 710 may support being configured with an SBFD configuration for one or more downlink or flexible slots in a TDD configuration). One or more operations described herein may be based on capability information. For example, the second network entity 710 may perform a communication in accordance with the capability information, or may receive configuration information that is in accordance with the capability information.

In some aspects, the capability information may indicate support for simultaneously receiving a downlink signal in a downlink subband and measuring CLI in an uplink subband (e.g., using an SRS RSRP measurement resource) during an SBFD time interval. For example, the configuration information may indicate that the second network entity 710 supports a capability to simultaneously receive serving cell DL signal/channel (e.g. PDSCH/PDCCH/CSI-RS) in the downlink subband and L1-SRS-RSRP in the uplink subband (e.g., similar to the measurement type 604).

In some aspects, the capability information may indicate support for simultaneously receiving a downlink signal in a downlink subband and measuring CLI in an uplink subband (e.g., using a CLI-RSSI measurement resource) during an SBFD time interval. For example, the second network entity 710 may support simultaneous reception of downlink data in a downlink subband during SBFD time intervals configured with a L1 CLI-RSSI measurement resource in an uplink subband or in a downlink subband.

As shown by reference number 720, the first network entity 705 may transmit, and the second network entity 710 may receive, configuration information. In some aspects, the second network entity 710 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the second network entity 710 or previously indicated by the network node or other network device), or explicit configuration information for the second network entity 710 to use to configure the second network entity 710, among other examples.

In some examples, the configuration information may not be expressly signaled to the second network entity 710. For example, in some aspects, the configuration information may at least partially be defined by a wireless communication standard, such as the 3GPP. In such examples, the first network entity 705 may not explicitly indicate such configuration information to the second network entity 710. For example, the second network entity 710 may optionally obtain at least a portion of the configuration information from a configuration stored by the second network entity 710 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include or indicate a TDD configuration (e.g., a TDD-UL-DL-ConfigCommon configuration). The TDD configuration may indicate a TDD pattern. The TDD pattern may indicate the allocation of time intervals for uplink and downlink transmissions within a given frequency band. The TDD pattern may enable coordination the timing of data transmissions and receptions, thereby ensuring efficient utilization of resources in a TDD system. The TDD pattern may indicate the sequence and duration of uplink and downlink OFDM symbols. For example, the TDD pattern may indicate a pattern of downlink symbols, uplink symbols, or flexible symbols. The TDD pattern may have a duration (e.g., a quantity of slots or subframes) and may repeat over time.

The configuration information may include or indicate an SBFD configuration. The SBFD configuration may indicate that one or more time intervals, indicated by the TDD pattern, are to be SBFD time intervals. An SBFD time interval may be a TDD time interval configured with one or more downlink subbands and one or more uplink subbands within a carrier bandwidth. In some examples, an SBFD time interval may include one uplink subband and two downlink subbands separated by guard bands.

In some aspects, the configuration information may indicate a configuration for one or more CLI measurement resources. For example, a CLI measurement resource may be configured via a resource configuration, such as a CSI resource configuration (e.g., a CSI-ResourceConfig). For example, the resource configuration may include one or more lists of CLI measurement resources. For example, the resource configuration may include a CLI measurement configuration (such as an SRS-RSRP-MeasurementResourceSet) that includes a set of one or more SRS-RSRP measurement resource(s) (e.g., one or more SRS-RSRP-MeasurementResource IEs) for L1 SRS-RSRP measurement. Additionally, or alternatively, the second network entity 710 may receive a CLI measurement configuration (such as anCLI-RSSI-MeasurementResourceSet) that includes a set of one or more CLI-RSSI measurement resource (e.g., one or more CLI-RSSI-MeasurementResource IEs) for L1 CLI-RSSI measurement. In some examples, the second network entity 710 may be configured to measure an RSSI of CLI within a downlink subband (e.g., via a CLI-RSSI measurement resource), as depicted in a measurement type 602 and FIG. 6. Additionally, or alternatively, the second network entity 710 may be configured to measure an RSRP of an aggressor network entity (e.g., an aggressor UE) within an uplink subband (e.g., via an SRS-RSRP measurement resource), as depicted in a measurement type 604 and FIG. 6. Additionally, or alternatively, the second network entity 710 may be configured to measure RSSI of CLI within an uplink subband (e.g., via a CLI-RSSI measurement resource), as depicted in a measurement type 606 and FIG. 6.

For example, the configuration information may indicate that a first CLI measurement resource is to occur in a first subband of a first SBFD time interval. The first CLI measurement resource may be a CLI-RSSI measurement resource or an SRS-RSRP measurement resource. In some aspects, the configuration information may indicate that a second CLI measurement resource is to occur in a second subband of a second SBFD time interval. The second CLI measurement resource may be a CLI-RSSI measurement resource or an SRS-RSRP measurement resource. In some aspects, the configuration information may indicate that a CLI-RSSI measurement resource is to occur in one or more downlink subbands (e.g., similar to the measurement type 602) and an SRS-RSRP measurement resource is to occur in an uplink subband (e.g., similar to the measurement type 604). As another example, the configuration information may indicate that a CLI-RSSI measurement resource is to occur in an uplink subband (e.g., similar to the measurement type 606) subbands and an SRS-RSRP measurement resource is to occur in the uplink subband (e.g., similar to the measurement type 604).

In some aspects, the configuration information may include a BWP configuration. The BWP configuration may indicate configurations for one or more BWPs. A configuration for a BWP may indicate frequency domain resource for the BWP. BWPs may be segments of the carrier bandwidth that can be dynamically configured to optimize resource allocation and adapt to varying network conditions. The BWP configuration may specify one or more BWPs, each configured to accommodate specific service requirements such as enhanced mobile broadband (eMBB), massive machine-type communications (mMTC), or URLLC, among other examples. By defining these configurations, the first network entity 705 may efficiently manage spectrum usage, prioritize traffic types, and reduce interference, thereby enhancing overall system performance. A configuration for a BWP may indicate frequency domain resources allocated to that BWP, detailing the specific subbands and channels available for communication. The granularity allows for flexible management of the radio environment, including the ability to adjust bandwidth allocations in response to traffic load, interference patterns, and user mobility. A BWP may be configured as an initial BWP, an active BWP, a serving BWP, or a configured BWP. A BWP may be configured for downlink or uplink.

In some aspects, the configuration information may indicate that the second network entity 710 is to perform CLI measurements in accordance with one or more conditions. In some aspects, the configuration information may indicate the one or more conditions. The one or more conditions may be evaluated based on the time intervals (e.g., the OFDM symbols) in which CLI measurement resources are configured. For example, in some aspects, a condition may indicate that a CLI-RSSI measurement resource cannot be configured in a downlink subband in an SBFD symbol that at least partially overlaps with an SBFD symbol in which an SRS-RSRP measurement resource is configured in an uplink subband. As another example, a condition may indicate that if a CLI-RSSI measurement resource and an SRS-RSRP measurement resource are both configured in an uplink subband and in SBFD symbols that at least partially overlap in time, then the CLI-RSSI measurement resource and the SRS-RSRP measurement resource are to use different frequency domain resources (e.g., different resource elements or different resource blocks). In some aspects, a condition may indicate that a downlink communication (e.g., a PDCCH communication, a PDSCH communication, a CSI-RS, or another downlink communication) cannot be scheduled or configured in a downlink subband in an SBFD symbol that at least partially overlaps with an SBFD symbol in which a CLI-RSSI measurement resource is configured in an uplink subband.

In some aspects, a condition may be evaluated based on the frequency domain configuration of a CLI measurement resource and an active BWP (e.g., an active downlink BWP). For example, a condition may indicate that if at least a portion of a CLI measurement resource is outside of an active downlink BWP, then one or more parameters of a CLI measurement are to be modified. The one or more parameters may include a measurement delay, a measurement accuracy, or another parameter.

In some aspects, the first network entity 705 may determine the configuration information based on, using, in accordance with, or otherwise associated with the one or more conditions. For example, the first network entity 705 may configure one or more CLI measurement resources such that the one or more conditions are satisfied, as described herein. Additionally, or alternatively, the first network entity 705 may schedule or configure one or more downlink communications or signals based on, using, in accordance with, or otherwise associated with the one or more conditions. For example, the first network entity 705 may schedule or configure one or more downlink communications or signals such that the one or more conditions are satisfied, as described herein.

The second network entity 710 may configure itself based on the configuration information. In some aspects, the second network entity 710 may be configured to perform one or more operations described herein based on the configuration information.

In some aspects, as shown by reference number 725, for a given SBFD time interval, the second network entity 710 may determine whether the one or more conditions for CLI measurement are satisfied. If the one or more conditions are satisfied, then the second network entity 710 may perform one or more CLI measurements (e.g., as depicted and described in connection with reference number 730) as configured by the configuration information. If a condition is not satisfied, then the second network entity 710 may skip at least one CLI measurement using a configured CLI measurement resource. For example, if a condition is not satisfied the second network entity 710 may consider it to be an error case. In such examples, handling of the error case may be up to implementation of the second network entity 710. For example, the second network entity 710 may skip performing a CLI measurement using one or all configured CLI measurement resources that caused the condition to not be satisfied.

For example, the second network entity 710 may evaluate the one or more conditions for a first CLI measurement resource (e.g., that is configured to occur in a first subband of a first SBFD time interval) and a second CLI measurement resource (e.g., that is configured to occur in a second subband of a second SBFD time interval). The evaluation of the one or more conditions may be based on the first SBFD time interval and the second SBFD time interval. For example, a condition may indicate that the first SBFD time interval and the second SBFD time interval are to be different time intervals (e.g., that do not overlap in the time domain). For example, the second network entity 710 may determine that the condition is satisfied based on the first SBFD time interval and the second SBFD time interval being different time intervals.

In some aspects, the second network entity 710 may determine that the condition is not satisfied based on the second SBFD time interval at least partially overlapping in time with the first SBFD time interval. For example, the first CLI measurement resource may be a CLI-RSSI measurement resource configured in one or more downlink subbands. The second measurement resource may be an SRS-RSRP measurement resource configured in an uplink subband. The condition may indicate that L1-CLI-RSSI measurements resources in one or more downlink subbands (e.g., that are configured in a similar manner as the measurement type 602) cannot be configured (partially or fully) on the same OFDM symbols as an L1-SRS-RSRP measurement resource (e.g., that is configured in a similar manner as the measurement type 604). For example, the second network entity 710 may not expect to be configured with L1-CLI-RSSI measurements resources in one or more downlink subbands (e.g., that are configured in a similar manner as the measurement type 602) and an L1-SRS-RSRP measurement resource in an uplink subband (e.g., that is configured in a similar manner as the measurement type 604) during the same (or overlapping in time) OFDM symbol(s).

The condition that L1-CLI-RSSI measurement resources in one or more downlink subbands cannot be configured on the same OFDM symbols as an L1-SRS-RSRP measurement resource may be put in place to prevent timing and resource allocation conflicts, which could degrade the accuracy and reliability of the measurements. L1-CLI-RSSI and L1-SRS-RSRP serve different purposes and employ distinct timing mechanisms (downlink and uplink, respectively), which means that overlapping their configurations could lead to erroneous interference measurements or signal misinterpretation. By ensuring these measurement resources are not configured on the same OFDM symbols, the first network entity 705 may accurately capture the necessary interference and signal strength data without cross-talk or interference from simultaneous measurements. This separation enhances the precision of interference management strategies, ultimately leading to improved spectral efficiency, reduced latency, and higher quality of service for network entities.

In some aspects, if the first SBFD time interval and the second SBFD time interval at least partially overlap in time, the condition may be satisfied based on a capability of the second network entity 710 (e.g., where the capability is indicated by the capability information described in connection with reference number 715). The capability may be that the second network entity 710 supports reception of a downlink signal in a downlink subband of an SBFD time interval and SRS RSRP CLI measurement in an uplink subband of the SBFD time interval. For example, the capability may be for simultaneous reception of a downlink signal in a downlink subband and measuring CLI in an uplink subband (e.g., using an SRS RSRP measurement resource) during an SBFD time interval. For example, if the second network entity 710 supports a capability to simultaneously receive a serving cell downlink signal or channel (e.g. a PDSCH communication, PDCCH communication, a CSI-RS, or another downlink signal or channel) in the downlink subband and L1-SRS-RSRP reception or measurement in the uplink subband (e.g., that is configured in a similar manner as the measurement type 604), then the second network entity 710 may determine that the condition is satisfied even if the first SBFD time interval and the second SBFD time interval at least partially overlap in time. For example, if the second network entity 710 supports a capability to simultaneously receive a serving cell downlink signal or channel (e.g. a PDSCH communication, PDCCH communication, a CSI-RS, or another downlink signal or channel) in the downlink subband and a L1-SRS-RSRP measurement resource in the uplink subband (e.g., that is configured in a similar manner as the measurement type 604), then the second network entity 710 may be configured with an L1 CLI-RSSI measurement resource in a downlink subband of an SBFD time interval that at least partially overlaps with an SBFD time interval in which an L1 SRS-RSRP measurement resource is configured in an uplink subband. For example, if the second network entity 710 supports the capability, then the second network entity 710 may support the measurement type 602 and the measurement type 604 in SBFD time intervals that fully or partially overlap in time.

As another example, the first CLI measurement resource may be a CLI-RSSI measurement resource configured in an uplink subband. The second CLI measurement resource may be an SRS-RSRP measurement resource configured in the uplink subband. In some aspects, the condition may indicate that the CLI-RSSI measurement resource and the SRS-RSRP measurement resource cannot be configured in the same (or overlapping in time) SBFD time intervals. In some aspects, the condition may indicate that the CLI-RSSI measurement resource and the SRS-RSRP measurement resource cannot be configured in the same (or overlapping in time) SBFD time intervals when the CLI-RSSI measurement resource and the SRS-RSRP measurement resource have at least partially overlapping frequency domain resources. For example, if the CLI-RSSI measurement resource and the SRS-RSRP measurement resource are configured with at least one common frequency domain resource (e.g., at least one common resource element or resource block), then the condition may indicate that the CLI-RSSI measurement resource and the SRS-RSRP measurement resource cannot be configured in the same (or overlapping in time) SBFD time intervals. For example, the condition may indicate that a first set of one or more frequency resources for the CLI-RSSI measurement resource are to be different than a second set of one or more frequency resources for the CLI SRS-RSRP measurement resource. The second network entity 710 may not expect to be configured with L1-CLI-RSSI measurements resources in an uplink subband (e.g., in a similar manner as the measurement type 606) and L1-SRS-RSRP measurement resource(s) in the uplink subband (e.g., in a similar manner as the measurement type 604) on the same symbol and same resource element(s) or resource block(s).

In some such aspects, the second network entity 710 may determine that the condition is satisfied based on the second network entity 710 supporting a capability to simultaneously perform the measurement type 604 and the measurement type 606 (e.g., to simultaneously perform CLI-RSSI CLI measurement and SRS-RSRP CLI measurement in an uplink subband of an SBFD time interval). The capability may be indicated by the capability information depicted and described in connection with reference number 715.

In some aspects, where the CLI-RSSI measurement resource and the SRS-RSRP measurement resource are configured in the same uplink subband, in at least partially overlapping SBFD time intervals, and with no common frequency domain resources (e.g., at least one common resource element or resource block), the second network entity 710 may determine that the condition is satisfied based on the second network entity 710 supporting a capability of the second network entity 710. The capability may be that the second network entity 710 supports reception of a downlink signal in a downlink subband of an SBFD time interval and SRS-RSRP CLI measurement in an uplink subband of the SBFD time interval, in a similar manner as described elsewhere herein. For example, if the second network entity 710 supports a capability to simultaneously receive a serving cell downlink signal or channel (e.g. a PDSCH communication, PDCCH communication, a CSI-RS, or another downlink signal or channel) in the downlink subband and L1-SRS-RSRP reception or measurement in the uplink subband (e.g., that is configured in a similar manner as the measurement type 604), then the second network entity 710 may determine that the condition is satisfied. For example, in such examples, the second network entity 710 may support being configured with L1-CLI-RSSI measurement resources in an uplink subband (e.g., in a similar manner as the measurement type 606), partially or fully overlapping with the L1-SRS-RSRP measurement resources (e.g., configured in a similar manner as the measurement type 604).

In some aspects, the first CLI measurement resource may be a CLI-RSSI measurement resource. In some such aspects, the condition may indicate that there is not to be any downlink communications or downlink signals configured or scheduled in SBFD time intervals that at least partially overlap with the SBFD time interval in which the CLI-RSSI measurement resource is configured. For example, the measurement type 602 or the measurement type 606 may involve the measurement of CLI using the RSSI. In some scenarios, a downlink signal may exhibit significantly higher strength relative to the interference levels intended for measurement by L1-CLI-RSSI measurement resources. Such disparity in signal strength may result in elevated levels of quantization noise during the measurement process. Quantization noise arises when the resolution of the measurement apparatus is insufficient to accurately capture the subtle variations of weaker interference signals amidst the presence of a dominant downlink signal. This increased quantization noise may adversely impact the precision and reliability of the L1-CLI-RSSI measurements, thereby affecting the overall efficacy of interference management strategies. Therefore, the condition may ensure that no downlink communication or signals are scheduled or configured to occur in the same SBFD time interval(s) during which the second network entity 710 is performing a CLI-RSSI measurement to reduce the likelihood of such quantization noise. For example, the second network entity 710 may determine that the condition is satisfied based on one or more downlink subbands of the first SBFD time interval being free of scheduled or configured downlink signals. Being “free” of scheduled or configured downlink signals may refer to no downlink signals being scheduled or configured in the first SBFD time interval. For example, the second network entity 710 may not expect to be scheduled or configured with a downlink data channel or downlink reference signal and L1-CLI-RSSI measurements resource in a downlink subband in the same OFDM symbol.

In some aspects, the second network entity 710 may support a capability for simultaneous downlink signal reception and L1-CLI-RSSI measurement. For example, the second network entity 710 may be capable of handling the quantization noise that may arise from simultaneous downlink signal reception and L1-CLI-RSSI measurement. In such examples, the second network entity 710 may determine that the condition is satisfied if the second network entity 710 is scheduled or configured with a downlink data channel or downlink reference signal and L1-CLI-RSSI measurements resource in the same OFDM symbol based on the second network entity 710 supporting the capability for simultaneous downlink signal reception and L1-CLI-RSSI measurement.

As shown by reference number 730, the second network entity 710 may perform, in accordance with the one or more conditions, one or more CLI measurements. For example, if the one or more conditions are satisfied, then the second network entity 710 may perform the one or more CLI measurement in accordance with the configuration information. For example, the second network entity 710 may perform, based on the condition being satisfied and during the first SBFD time interval, a first set of one or more CLI measurements using the first CLI measurement resource. Additionally, the second network entity 710 may perform, based on the condition being satisfied and during the second SBFD time interval, a second set of one or more CLI measurements using the second CLI measurement resource. In some aspects, the first set of one or more CLI measurements may be CLI-RSSI measurements and the second set of one or more CLI measurements may be SRS-RSRP measurements. As another example, the second network entity 710 may perform, based on a capability of the second network entity 710 and during the first SBFD time interval, the one or more CLI measurements, where the capability is that the network entity supports reception of downlink signals and CLI-RSSI measurement in a same SBFD time interval (e.g., where the SBFD time interval includes a scheduled or configured downlink signal).

Alternatively, if a condition is not satisfied, then the second network entity 710 may consider it to be an error case. In such examples, the second network entity 710 may perform an action to mitigate or resolve the error case. As an example, the second network entity 710 may perform, based on the condition not being satisfied, the one or more CLI measurements using only one of the first CLI measurement resource or the second CLI measurement resource. In such examples, the second network entity 710 may skip (or refrain from performing) measuring CLI using one of the first CLI measurement resource or the second CLI measurement resource.

The second network entity 710 may perform the one or more CLI measurements to obtain CLI measurement information. The CLI measurement information may indicate one or more values, such as RSSI values or RSRP values that are based on, or otherwise associated with, the one or more CLI measurements.

In some aspects, the configuration information may indicate a BWP, such as a downlink BWP configured for the second network entity 710. In some aspects, a configured CLI measurement resource may be configured in one or more frequency domain resources that are outside of (e.g., not included in) the BWP. In such examples, one or more one or more parameters of the CLI measurement information may be based on the BWP and the one or more subbands in which the CLI measurement resource is configured. For example, if the one or more subbands are inside of the BWP, then the one or more CLI measurements may use, or be associated with, one or more first parameters. If the one or more subbands are outside of the BWP, then the one or more CLI measurements may use, or be associated with, one or more second parameters.

The parameter(s) may include a measurement delay, a measurement accuracy, or another parameter. In the context of wireless communication systems, the parameters related to measurement resources may enable accurate and timely interference assessments. A measurement delay parameter may indicate the time interval required to complete a measurement process, which can impact the speed and responsiveness of network adaptations to interference conditions. Measurement accuracy may refer refers to the precision with which the measurement reflects the true signal characteristics, directly influencing the effectiveness of interference mitigation strategies. These parameters, alongside others, may enable the first network node 705 to optimize the performance of cross-link interference management and maintaining high quality of service in dynamic communication environments.

As an example, the BWP may include first frequency domain resources, the one or more subbands of the CLI measurement resource may include a first subband and a second subband. In some aspects, the first subband may be included in the first frequency domain resources, and the second subband may be outside of the first frequency domain resources. In such examples, the measurement delay may be based on, or reflect, multiple CLI measurements by the second network entity 710. For example, to measure CLI in such examples, the second network entity 710 may perform, using the first subband and the first SBFD time interval, a first CLI measurement. The second network entity 710 may perform, using the second subband and a second SBFD time interval, a second CLI measurement. For example, the second network entity 710 may switch to a different BWP that includes the second subband or perform RF retuning to the frequency resource(s) of the second subband to perform the second CLI measurement. As a result, the measurement delay may reflect or indicate that time to perform or process the first CLI measurement and the second CLI measurement. In some aspects, the measurement delay for performing L1-CLI-RSSI measurements using the measurement type 602 may be double of that for a network entity that supports simultaneous downlink reception on two downlink subbands (e.g., because the second network entity 710 may need to perform CLI measurements in two separate time intervals, whereas the other network entity can perform the CLI measurement in two subbands in the same SBFD time interval). In other words, the measurement delay may be based on two measurement samples, but the measurement accuracy may remain the same.

As another example, the measurement accuracy may reflect that the CLI measurement is based on a single sample. For example, the measurement delay may be based on a single sample, but the measurement accuracy may be reduced or relaced to reflect that only a single sample is used to obtain the RSSI CLI measurement. For example, the second network entity 710 ma perform one or more CLI measurements only the L1-CLI-RSSI measurement resources in a single subband (e.g., where the CLI-RSSI measurement resources are configured in multiple subbands). This may reduce and interruptions or scheduling restrictions on the downlink data.

As another example, the measurement delay and the measurement accuracy may be the same as if the second network entity 710 supported simultaneous downlink reception on two downlink subbands. In such examples, the second network entity 710 may switch to a BWP or retune an RF front end to enable the second network entity 710 to perform CLI measurements in multiple subbands using the configured CLI measurement resource. In some aspects, the configuration information may indicate which BWP the second network entity 710 is to switch to for performing the one or more CLI measurements (e.g., in an RRC configuration or in a configuration for the CLI measurement resource(s)). If the configuration does not indicate which BWP the second network entity 710 is to switch to for performing the one or more CLI measurements, the second network entity 710 may autonomously determine which BWP is to be used to perform the one or more CLI measurements.

As shown by reference number 735, the second network entity 710 may transmit, and the first network entity 705 may receive, a CLI measurement report. The CLI measurement report may indicate or include the CLI measurement information (e.g., obtained as described in connection with reference number 730). For example, the CLI measurement information may indicate one or more CLI RSSI values or one or more CLI SRS-RSRP values.

As indicated above, FIG. 7 is provided as an example. Other examples may differ from what is described with respect to FIG. 7.

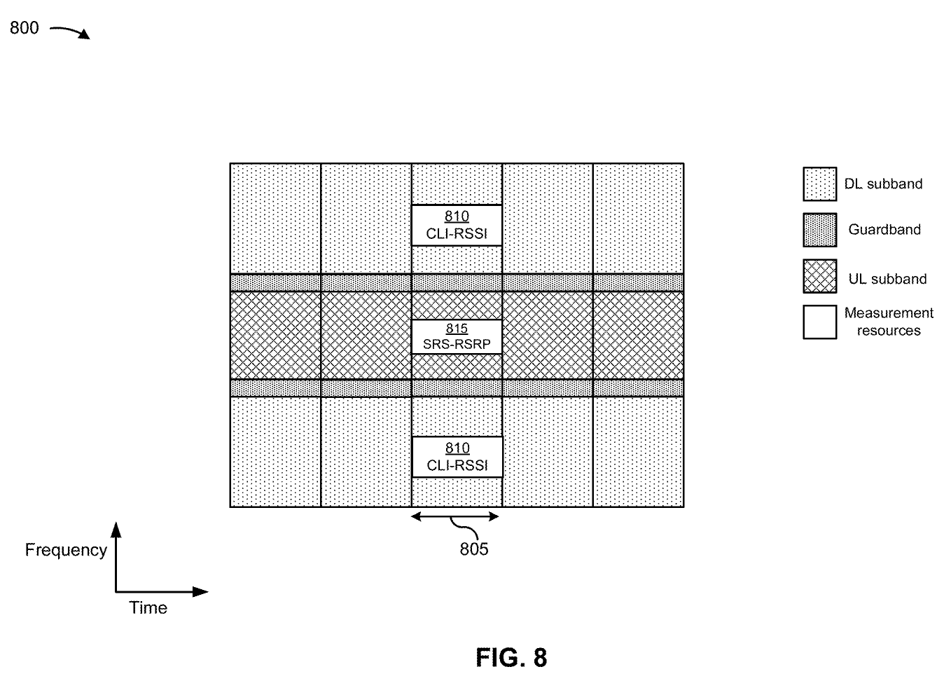

FIG. 8 is a diagram of an example 800 associated with CLI measurement conditions. FIG. 8 depicts an example in which an SBFD time interval 805 includes CLI-RSSI measurement resources 810 configured in one or more downlink subbands and an SRS-RSRP CLI measurement resource 815 configured in an uplink subband. In some aspects, a condition may not be satisfied based on the CLI-RSSI measurement resources 810 and the SRS-RSRP CLI measurement resource 815 being configured in the same SBFD time interval 805.

In some other aspects, the condition may be satisfied based on a capability of a network entity performing the CLI measurements (e.g., the second network entity 710). For example, if the network entity supports reception of a downlink signal in a downlink subband of an SBFD time interval and SRS RSRP CLI measurement in an uplink subband of the SBFD time interval, then the condition may be satisfied in the scenario depicted in FIG. 8.

As indicated above, FIG. 8 is provided as an example. Other examples may differ from what is described with respect to FIG. 8.

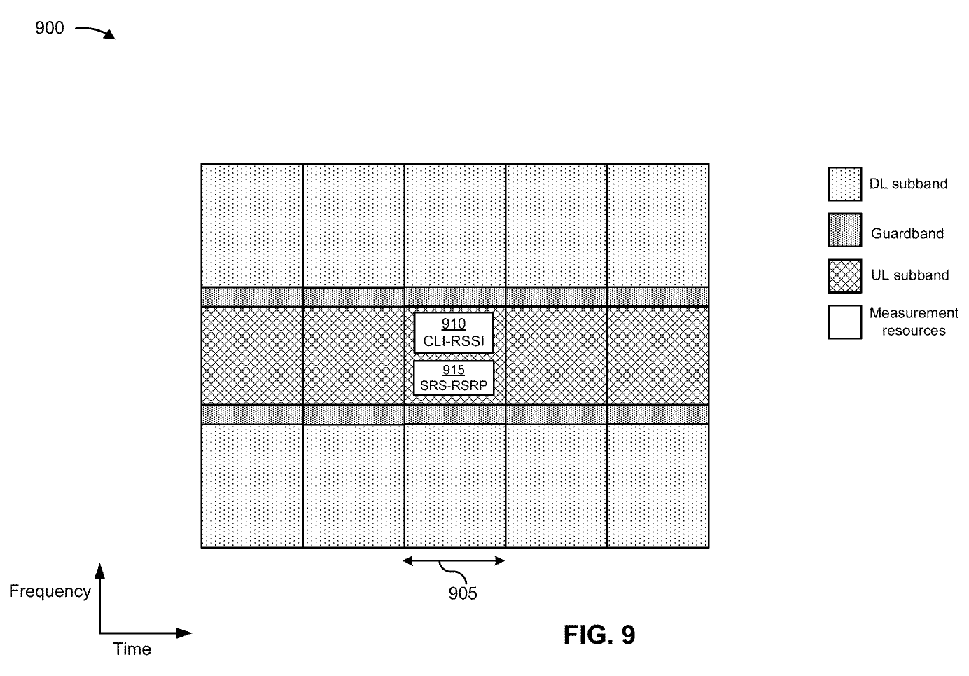

FIG. 9 is a diagram of an example 900 associated with CLI measurement conditions. FIG. 9 depicts an example in which an SBFD time interval 905 includes a CLI-RSSI measurement resource 910 configured in an uplink subband of the SBFD time interval 905 and an SRS-RSRP CLI measurement resource 915 configured in the uplink subband. In some aspects, the condition may be satisfied based on the CLI-RSSI measurement resource 910 and the SRS-RSRP CLI measurement resource 915 being configured with different (or non-overlapping in the frequency domain) frequency domain resources. For example, if the CLI-RSSI measurement resource 910 and the SRS-RSRP CLI measurement resource 915 were to have one or more common frequency domain resources (e.g., if the CLI-RSSI measurement resource 910 and the SRS-RSRP CLI measurement resource 915 were to at least partially overlap in the frequency domain), then the condition may not be satisfied.

As indicated above, FIG. 9 is provided as an example. Other examples may differ from what is described with respect to FIG. 9.

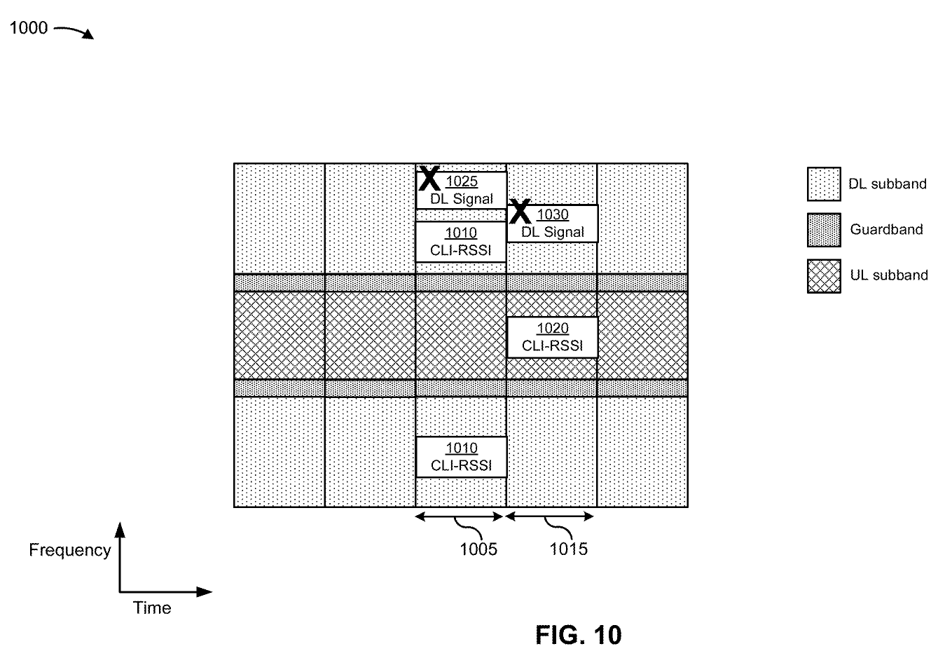

FIG. 10 is a diagram of an example 1000 associated with CLI measurement conditions. As shown in FIG. 10, one or more CLI-RSSI measurement resources 1010 may be configured in one or more downlink subbands of an SBFD time interval 1005. In some aspects, the condition may be satisfied based on the downlink subband(s) of the SBFD time interval 1005 being free of scheduled or configured downlink signals. For example, as shown in FIG. 10, if a downlink signal 1025 is configured in the downlink subband of the SBFD time interval 1005, then the condition may not be satisfied. In such examples, a network entity (e.g., the second network entity 710) may skip reception of the downlink signal 1025 or may skip performing CLI measurement using the one or more CLI-RSSI measurement resources 1010.

As another example, a CLI-RSSI measurement resource 1020 may be configured in an uplink subband on an SBFD time interval 1015. In some aspects, the condition may be satisfied based on the downlink subband(s) of the SBFD time interval 1015 being free of scheduled or configured downlink signals. For example, as shown in FIG. 10, if a downlink signal 1030 is configured in the downlink subband of the SBFD time interval 1015, then the condition may not be satisfied. In such examples, a network entity (e.g., the second network entity 710) may skip reception of the downlink signal 1030 or may skip performing CLI measurement using the CLI-RSSI measurement resource 1020.

In some aspects, a network entity (e.g., the second network entity 710) may support a capability for simultaneous downlink signal reception and CLI RSSI measurement. In such examples, the condition may be satisfied for the SBFD time interval 1005. For example, the network entity may support receiving the downlink signal 1025 and performing CLI measurement using the one or more CLI-RSSI measurement resources 1010. Additionally, or alternatively, the network entity may support receiving the downlink signal 1030 and performing CLI measurement using the one or more CLI-RSSI measurement resources 1020.

As indicated above, FIG. 10 is provided as an example. Other examples may differ from what is described with respect to FIG. 10.

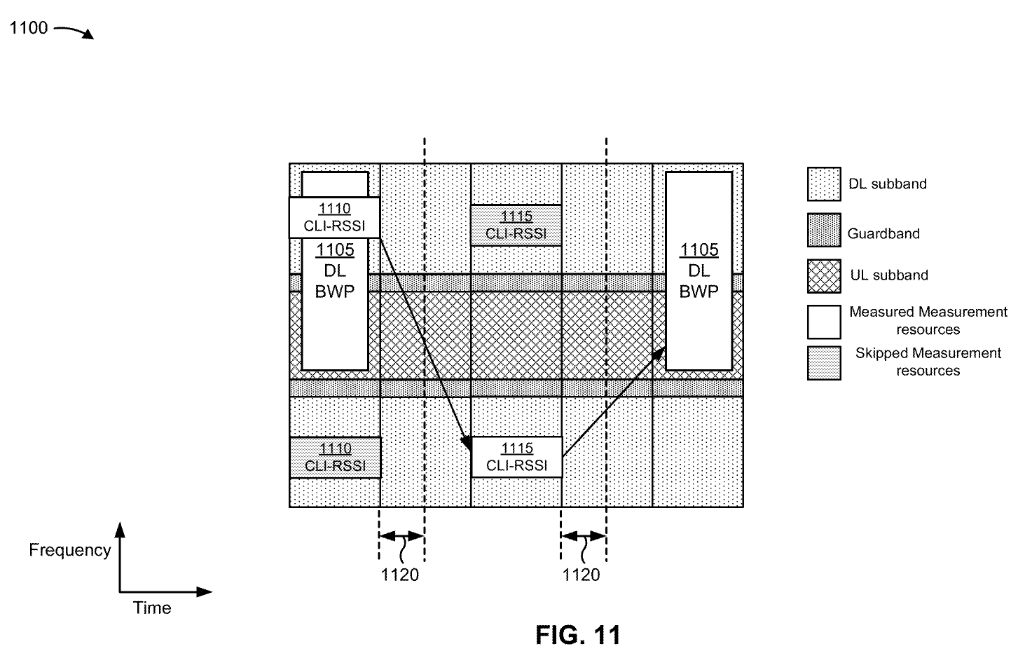

FIG. 11 is a diagram of an example 1100 associated with CLI measurement. As shown in FIG. 11, one or more CLI-RSSI measurement resources may be configured in downlink subbands of SBFD time intervals. For example, one or more CLI-RSSI measurement resources 1110 and one or more CLI-RSSI measurement resources 1115 may be configured in downlink subbands of SBFD time intervals. In some examples, a network entity (e.g., the second network entity 710) may not support downlink reception or measurement in multiple downlink subbands of a given SBFD time interval. In such examples, a downlink BWP 1105 for the network entity may be configured such that the downlink BWP 1105 only includes frequency domain resources of a single downlink subband.

Therefore, to perform CLI RSSI measurement, an adjustment to one or more parameters, such as a measurement delay or measurement accuracy may be performed. For example, as shown in FIG. 11, the network entity may perform a CLI measurement using a CLI-RSSI measurement resource 1115 that is included in the downlink BWP 1105 during a first SBFD time interval. During the first SBFD time interval, the network entity may skip performing a CLI measurement using a CLI-RSSI measurement resource 1115 that is outside of the downlink BWP 1105. In a second SBFD time interval, the network entity may perform a CLI measurement using the CLI-RSSI measurement resource 1115 that is outside of the downlink BWP 1105. For example, the network entity may switch BWPs or perform RF retuning during times 1120 to enable the network entity to perform a CLI measurement using the CLI-RSSI measurement resource 1115 that is outside of the downlink BWP 1105. In such examples, a measurement delay for CLI RSSI measurement may reflect the amount of time needed to perform the CLI measurement in the first SBFD time interval and the CLI measurement in the second SBFD time interval. The measurement accuracy may remain unmodified because the network entity measures both configured CLI-RSSI measurement resources 1115. As used herein, an “unmodified” parameter may refer to a value of the parameter as if the CLI measurement were performed as configured.

In some other aspects, the network entity may only perform CLI measurement in the first SBFD time interval (e.g., skipping the CLI measurement of the CLI-RSSI measurement resource 1115 that is outside of the downlink BWP 1105). In such examples, the measurement accuracy may be reduced or relaxed because the network entity only measures CLI RSSI using a single sample (e.g., rather than both configured CLI-RSSI measurement resources 1115). In such examples, the measurement delay may be unmodified.

As indicated above, FIG. 11 is provided as an example. Other examples may differ from what is described with respect to FIG. 11.

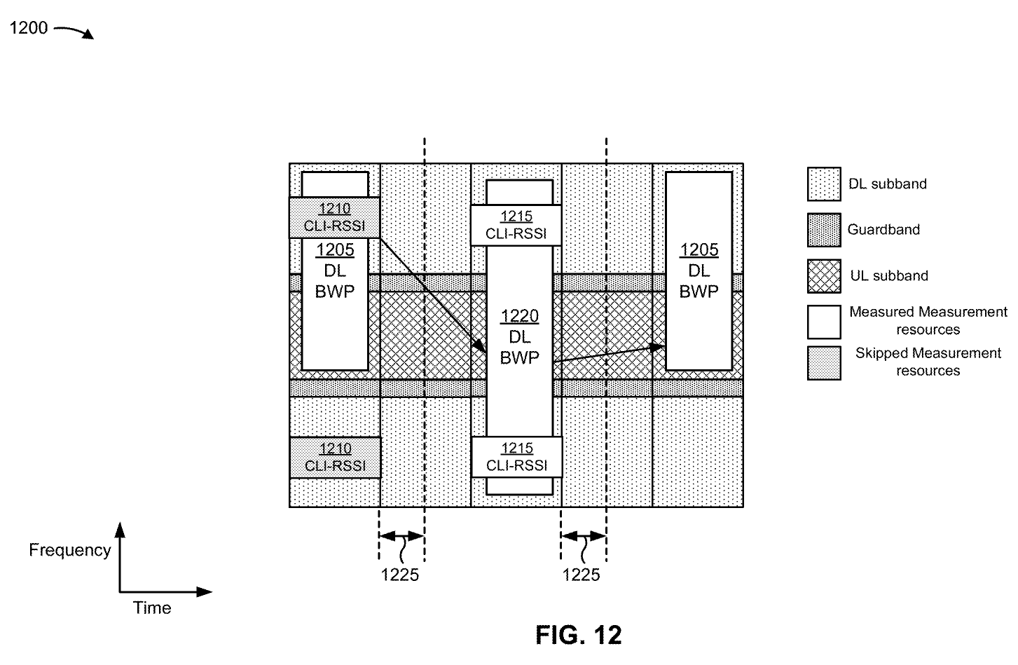

FIG. 12 is a diagram of an example 1200 associated with CLI measurement. As shown in FIG. 12, one or more CLI-RSSI measurement resources may be configured in downlink subbands of SBFD time intervals. For example, one or more CLI-RSSI measurement resources 1210 and one or more CLI-RSSI measurement resources 1215 may be configured in downlink subbands of SBFD time intervals. In some examples, a network entity (e.g., the second network entity 710) may not support downlink reception or measurement in multiple downlink subbands of a given SBFD time interval. In such examples, a downlink BWP 1205 for the network entity may be configured such that the downlink BWP 1205 only includes frequency domain resources of a single downlink subband.

In such examples, the network entity may perform an action to enable the network entity may perform CLI measurement in multiple downlink subbands. For example, the network entity may switch to a downlink BWP 1220, which may include both downlink subbands in which CLI-RSSI measurement resources 1215 are configured. The network entity may perform CLI RSSI measurement using the CLI-RSSI measurement resources 1215 and the downlink BWP 1220. As shown in FIG. 12, switching to the downlink BWP 1220 may be associated with a BWP switching time 1225 (e.g., associated with the network entity retuning or adjusting one or more components to enable the network entity to use the downlink BWP 1220 or the downlink BWP 1205). In such examples, the measurement accuracy and the measurement delay for the CLI RSSI measurement may be unmodified.

As indicated above, FIG. 12 is provided as an example. Other examples may differ from what is described with respect to FIG. 12.

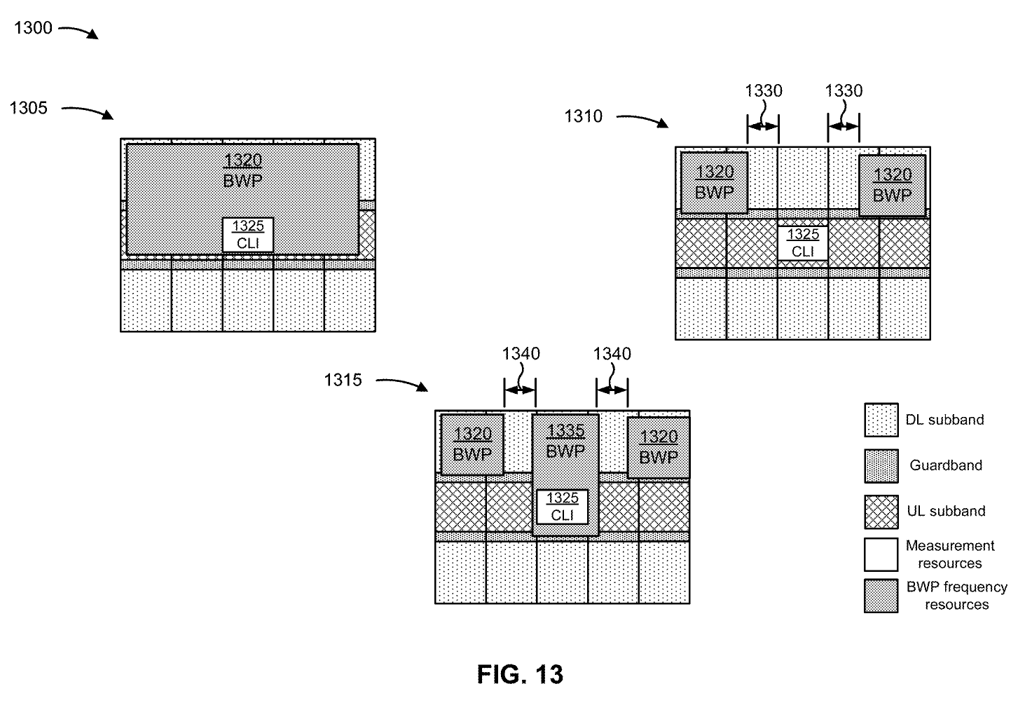

FIG. 13 is a diagram of an example 1300 associated with CLI measurement. FIG. 13 depicts a first example 1305, a second example 1310, and a third example 1315. In the examples depicted in FIG. 13, a network entity (e.g., the second network entity 710) may be configured with a first BWP 1320. The first BWP 1320 may be a downlink BWP or an active BWP. The network entity may be configured with a CLI measurement resource 1325. The CLI measurement resource 1325 may be configured in an uplink subband of an SBFD time interval. In some aspects, the CLI measurement resource 1325 may be a CLI-RSSI measurement resource. In other aspects, the CLI measurement resource 1325 may be an SRS-RSRP measurement resource.

In the first example 1305, the first BWP 1320 may include the uplink subband or the frequency domain resources of the CLI measurement resource 1325. Therefore, the network entity may be enabled to measure the CLI measurement resource 1325 using the first BWP 1320. Additionally, there may be no scheduling restrictions for downlink scheduling because the network entity is able to use the first BWP 1320 to measure CLI using the CLI measurement resource 1325.

In the second example 1310, the first BWP 1320 may not include the uplink subband or the frequency domain resources of the CLI measurement resource 1325. In such examples, the network entity may perform a retuning operation to tune an RF front end of the network entity to the uplink subband or the frequency domain resources of the CLI measurement resource 1325. After performing the retuning operation, the network entity may perform a CLI measurement using the CLI measurement resource 1325. After performing the CLI measurement, the network entity may perform a retuning operation to tune an RF front end of the network entity to the first downlink BWP 1320. As shown in FIG. 13, the retuning operation may be associated with retuning times 1330 during which the network entity is performing the retuning operation. In the second example 1310, there may be a scheduling restriction or condition on downlink scheduling that indicates that no downlink data or signals are to be scheduled or configured during the retuning times 1330 or during the time resources associated with the CLI measurement resource 1325. For example, if the network entity performs the CLI measurements by retuning the RF front end, there may be interruptions or scheduling restrictions on downlink data before, during and after the CLI measurement resource 1325.

In the third example 1315, the first BWP 1320 may not include the uplink subband or the frequency domain resources of the CLI measurement resource 1325. In such examples, the network entity may perform BWP switching operation to switch to a second BWP 1335 that does include the uplink subband or the frequency domain resources of the CLI measurement resource 1325. After performing the BWP switching operation, the network entity may perform a CLI measurement using the CLI measurement resource 1325. After performing the CLI measurement, the network entity may perform a BWP switching operation to switch back to the first downlink BWP 1320. As shown in FIG. 13, the BWP switching operation may be associated with BWP switching times 1340 during which the network entity is performing the BWP switching operation. In the third example 1315, there may be a scheduling restriction or condition on downlink scheduling that indicates that no downlink data or signals are to be scheduled or configured during the BWP switching times 1340 or during the time resources associated with the CLI measurement resource 1325. For example, if the network entity performs the CLI measurements by performing BWP switching, there may be interruptions or scheduling restrictions on downlink data before, during and after the CLI measurement resource 1325. In some aspects, the network entity may be configured to use the second BWP 1335 for CLI measurement.

As indicated above, FIG. 13 is provided as an example. Other examples may differ from what is described with respect to FIG. 13.

FIG. 14 is a diagram illustrating an example process 1400 performed, for example, at a network entity or an apparatus of a network entity. Example process 1400 is an example where the apparatus or the network entity (e.g., the second network entity 710) performs operations associated with CLI measurement conditions.

As shown in FIG. 14, in some aspects, process 1400 may include receiving first information indicating that a first CLI measurement resource is to occur in a first subband of a first SBFD time interval (block 1410). For example, the network entity (e.g., using reception component 1802 or communication manager 1806, depicted in FIG. 18) may receive first information indicating that a first CLI measurement resource is to occur in a first subband of a first SBFD time interval, as described above.

As further shown in FIG. 14, in some aspects, process 1400 may include receiving second information indicating that a second CLI measurement resource is to occur in a second subband of a second SBFD time interval (block 1420). For example, the network entity (e.g., using reception component 1802 or communication manager 1806, depicted in FIG. 18) may receive second information indicating that a second CLI measurement resource is to occur in a second subband of a second SBFD time interval, as described above.

As further shown in FIG. 14, in some aspects, process 1400 may include performing, in accordance with a condition, one or more CLI measurements using at least one of the first CLI measurement resource or the second CLI measurement resource, wherein the condition is evaluated based on the first SBFD time interval and the second SBFD time interval (block 1430). For example, the network entity (e.g., using communication manager 1806, depicted in FIG. 18) may perform, in accordance with a condition, one or more CLI measurements using at least one of the first CLI measurement resource or the second CLI measurement resource, wherein the condition is evaluated based on the first SBFD time interval and the second SBFD time interval, as described above.

Process 1400 may include additional aspects, such as any single aspect or any combination of aspects described below or in connection with one or more other processes described elsewhere herein.

In a first aspect, the condition is satisfied based on the first SBFD time interval and the second SBFD time interval being different time intervals, and wherein performing the one or more CLI measurements includes performing, based on the condition being satisfied and during the first SBFD time interval, a first set of one or more CLI measurements using the first CLI measurement resource, and performing, based on the condition being satisfied and during the second SBFD time interval, a second set of one or more CLI measurements using the second CLI measurement resource.

In a second aspect, alone or in combination with the first aspect, the second SBFD time interval at least partially overlaps in time with the first SBFD time interval, wherein the condition is not satisfied based on the second SBFD time interval at least partially overlapping in time with the first SBFD time interval, and wherein performing the one or more CLI measurements includes performing, based on the condition not being satisfied, the one or more CLI measurements using only one of the first CLI measurement resource or the second CLI measurement resource.

In a third aspect, alone or in combination with one or more of the first and second aspects, the first CLI measurement resource is a CLI RSSI measurement resource, wherein the first subband includes one or more downlink subbands, wherein the second CLI measurement resource is a CLI SRS RSRP measurement resource, and wherein the second subband includes one or more uplink subbands.

In a fourth aspect, alone or in combination with one or more of the first through third aspects, the first CLI measurement resource is a CLI RSSI measurement resource, wherein the first subband includes an uplink subband, wherein the second CLI measurement resource is a CLI SRS RSRP measurement resource, and wherein the second subband includes the uplink subband.

In a fifth aspect, alone or in combination with one or more of the first through fourth aspects, the condition indicates that a first set of one or more frequency resources for the CLI RSSI measurement resource are to be different than a second set of one or more frequency resources for the CLI SRS RSRP measurement resource.

In a sixth aspect, alone or in combination with one or more of the first through fifth aspects, the second SBFD time interval at least partially overlaps in time with the first SBFD time interval, and wherein the condition is satisfied based on a capability of the network entity, wherein the capability is that the network entity supports reception of a downlink signal in a downlink subband of an SBFD time interval and SRS RSRP CLI measurement in an uplink subband of the SBFD time interval.

In a seventh aspect, alone or in combination with one or more of the first through sixth aspects, performing the one or more CLI measurements includes performing, based on the condition being satisfied and during the first SBFD time interval, a first set of one or more CLI measurements using the first CLI measurement resource, and performing, based on the condition being satisfied and during the second SBFD time interval, a second set of one or more CLI measurements using the second CLI measurement resource.

In an eighth aspect, alone or in combination with one or more of the first through seventh aspects, the first CLI measurement resource is a CLI RSSI measurement resource, wherein one or more downlink subbands of the first SBFD time interval is free of scheduled or configured downlink signals, and wherein the condition is satisfied based on the one or more downlink subbands of the first SBFD time interval being free of scheduled or configured downlink signals.

In a ninth aspect, alone or in combination with one or more of the first through eighth aspects, the first CLI measurement resource is a CLI RSSI measurement resource, and process 1400 includes receiving third information indicating that a downlink signal is to occur in a downlink subband of the first SBFD time interval, and wherein performing the one or more CLI measurements includes performing, based on a capability of the network entity and during the first SBFD time interval, the one or more CLI measurements, wherein the capability is that the network entity supports reception of downlink signals and RSSI CLI measurement in a same SBFD time interval.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a network entity or an apparatus of a network entity. Example process 1500 is an example where the apparatus or the network entity (e.g., the first network entity 705) performs operations associated with CLI measurement conditions.

As shown in FIG. 15, in some aspects, process 1500 may include transmitting first information, for a second network entity, indicating that a first CLI measurement resource is to occur in a first subband of a first SBFD time interval (block 1510). For example, the network entity (e.g., using transmission component 1904 or communication manager 1906, depicted in FIG. 19) may transmit first information, for a second network entity, indicating that a first CLI measurement resource is to occur in a first subband of a first SBFD time interval, as described above.

As further shown in FIG. 15, in some aspects, process 1500 may include transmitting, based on a condition being satisfied, second information, for the second network entity, indicating that a second CLI measurement resource is to occur in a second subband of a second SBFD time interval, wherein the condition is evaluated based on the first SBFD time interval and the second SBFD time interval (block 1520). For example, the network entity (e.g., using transmission component 1904 or communication manager 1906, depicted in FIG. 19) may transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval, as described above.

Process 1500 may include additional aspects, such as any single aspect or any combination of aspects described below or in connection with one or more other processes described elsewhere herein.

In a first aspect, the condition is satisfied based on the first SBFD time interval and the second SBFD time interval being different time intervals.

In a second aspect, alone or in combination with the first aspect, the first CLI measurement resource is a CLI RSSI measurement resource, wherein the first subband includes one or more downlink subbands, wherein the second CLI measurement resource is a CLI SRS RSRP measurement resource, and wherein the second subband includes one or more uplink subbands.

In a third aspect, alone or in combination with one or more of the first and second aspects, the first CLI measurement resource is a CLI RSSI measurement resource, wherein the first subband includes an uplink subband, wherein the second CLI measurement resource is a CLI SRS RSRP measurement resource, and wherein the second subband includes the uplink subband.

In a fourth aspect, alone or in combination with one or more of the first through third aspects, the CLI RSSI measurement resource includes a first set of one or more frequency domain resources in the uplink subband, wherein the CLI SRS RSRP measurement resource includes a second set of one or more frequency domain resources in the uplink subband, wherein the first set of one or more frequency domain resources is different than the second set of one or more frequency domain resources, and wherein the condition is satisfied based on the first set of one or more frequency domain resources being different than the second set of one or more frequency domain resources.

In a fifth aspect, alone or in combination with one or more of the first through fourth aspects, the second SBFD time interval at least partially overlaps in time with the first SBFD time interval, and wherein the condition is satisfied based on a capability of the second network entity, wherein the capability is that the second network entity supports reception of a downlink signal in a downlink subband of an SBFD time interval and SRS RSRP CLI measurement in an uplink subband of the SBFD time interval.

In a sixth aspect, alone or in combination with one or more of the first through fifth aspects, the first CLI measurement resource is a CLI RSSI measurement resource, wherein one or more downlink subbands of the first SBFD time interval is free of scheduled or configured downlink signals, and wherein the condition is satisfied based on the one or more downlink subbands of the first SBFD time interval being free of scheduled or configured downlink signals.

In a seventh aspect, alone or in combination with one or more of the first through sixth aspects, the first CLI measurement resource is a CLI RSSI measurement resource, and process 1500 includes transmitting, based on a capability of the second network entity, third information indicating that a downlink signal is to occur in a downlink subband of the first SBFD time interval, wherein the capability is that the second network entity supports reception of downlink signals and RSSI CLI measurement in a same SBFD time interval.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a network entity or an apparatus of a network entity. Example process 1600 is an example where the apparatus or the network entity (e.g., the second network entity 710) performs operations associated with CLI measurement conditions.

As shown in FIG. 16, in some aspects, process 1600 may include receiving first information indicating a first BWP (block 1610). For example, the network entity (e.g., using reception component 1802 or communication manager 1806, depicted in FIG. 18) may receive first information indicating a first BWP, as described above.

As further shown in FIG. 16, in some aspects, process 1600 may include receiving second information indicating that a CLI measurement resource is to occur in one or more subbands of a first SBFD time interval (block 1620). For example, the network entity (e.g., using reception component 1802 or communication manager 1806, depicted in FIG. 18) may receive second information indicating that a CLI measurement resource is to occur in one or more subbands of a first SBFD time interval, as described above.

As further shown in FIG. 16, in some aspects, process 1600 may include performing, using the CLI measurement resource, one or more CLI measurements to obtain CLI measurement information, wherein one or more parameters of the CLI measurement information are based on the first BWP and the one or more subbands (block 1630). For example, the network entity (e.g., using communication manager 1806, depicted in FIG. 18) may perform, using the CLI measurement resource, one or more CLI measurements to obtain CLI measurement information, wherein one or more parameters of the CLI measurement information are based on the first BWP and the one or more subbands, as described above.

As further shown in FIG. 16, in some aspects, process 1600 may include transmitting third information indicating the CLI measurement information (block 1640). For example, the network entity (e.g., using transmission component 1804 or communication manager 1806, depicted in FIG. 18) may transmit third information indicating the CLI measurement information, as described above.

Process 1600 may include additional aspects, such as any single aspect or any combination of aspects described below or in connection with one or more other processes described elsewhere herein.

In a first aspect, the one or more parameters include a measurement delay, wherein the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements includes performing, using the first subband and the first SBFD time interval, a first CLI measurement, and performing, using the second subband and a second SBFD time interval, a second CLI measurement, wherein the measurement delay is based on an amount of time to perform first CLI measurement and the second CLI measurement.

In a second aspect, alone or in combination with the first aspect, the one or more parameters include a measurement accuracy, and wherein the measurement accuracy is unmodified based on the first CLI measurement and the second CLI measurement being performed.

In a third aspect, alone or in combination with one or more of the first and second aspects, the one or more parameters include a measurement accuracy, wherein the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements includes performing, using the first subband and the first SBFD time interval, a first CLI measurement, and skipping performance of a second CLI measurement using the second subband, wherein the measurement accuracy is based on the second CLI measurement being skipped.

In a fourth aspect, alone or in combination with one or more of the first through third aspects, the one or more parameters include a measurement delay, and wherein the measurement delay is unmodified based on the second CLI measurement being skipped.

In a fifth aspect, alone or in combination with one or more of the first through fourth aspects, the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements includes switching from the first BWP to a second BWP, wherein the second BWP includes second frequency domain resources, and wherein both the first subband and the second subband are included in the second frequency domain resources, and performing, using the second BWP and during the first SBFD time interval, the one or more CLI measurements, wherein the one or more parameters are based on the one or more CLI measurements.

In a sixth aspect, alone or in combination with one or more of the first through fifth aspects, process 1600 includes receiving configuration information that indicates the second BWP.

In a seventh aspect, alone or in combination with one or more of the first through sixth aspects, the configuration information is included in the second information.

In an eighth aspect, alone or in combination with one or more of the first through seventh aspects, the first BWP includes first frequency domain resources, wherein the CLI measurement resource includes second frequency domain resources that are included in the first frequency domain resources, and process 1600 includes receiving, via a one or more second subbands in the first SBFD time interval, one or more signals based on the second frequency domain resources being included in the first frequency domain resources.

In a ninth aspect, alone or in combination with one or more of the first through eighth aspects, the first BWP includes first frequency domain resources, wherein the CLI measurement resource includes second frequency domain resources, wherein the second frequency domain resources are outside of the first frequency domain resources, and process 1600 includes receiving scheduling information for one or more signals, wherein the scheduling information is subject to one or more conditions that are based on the second frequency domain resources being outside of the first frequency domain resources.

In a tenth aspect, alone or in combination with one or more of the first through ninth aspects, performing the one or more CLI measurements includes performing, during one or more switch times, one or more switches between the first frequency domain resources and the second frequency domain resources, wherein the one or more conditions indicate that the scheduling information is to schedule signals in one or more times that are outside of the one or more switch times and the first SBFD time interval.

In an eleventh aspect, alone or in combination with one or more of the first through tenth aspects, the one or more switch times are one or more radio frequency retuning times.

In a twelfth aspect, alone or in combination with one or more of the first through eleventh aspects, the one or more switch times are one or more radio BWP switching times.

In a thirteenth aspect, alone or in combination with one or more of the first through twelfth aspects, the CLI measurement resource is a CLI RSSI measurement resource.

In a fourteenth aspect, alone or in combination with one or more of the first through thirteenth aspects, the CLI measurement resource is a CLI SRS RSRP measurement resource.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a network entity or an apparatus of a network entity. Example process 1700 is an example where the apparatus or the network entity (e.g., the first network entity 705) performs operations associated with CLI measurement conditions.

As shown in FIG. 17, in some aspects, process 1700 may include transmitting first information indicating a first BWP (block 1710). For example, the network entity (e.g., using transmission component 1904 or communication manager 1906, depicted in FIG. 19) may transmit first information indicating a first BWP, as described above.

As further shown in FIG. 17, in some aspects, process 1700 may include transmitting second information indicating that a CLI measurement resource is to occur in one or more subbands of a first SBFD time interval (block 1720). For example, the network entity (e.g., using transmission component 1904 or communication manager 1906, depicted in FIG. 19) may transmit second information indicating that a CLI measurement resource is to occur in one or more subbands of a first SBFD time interval, as described above.

As further shown in FIG. 17, in some aspects, process 1700 may include receiving third information indicating CLI measurement information, wherein one or more parameters of the CLI measurement information are based on the first BWP and the one or more subbands (block 1730). For example, the network entity (e.g., using reception component 1902 or communication manager 1906, depicted in FIG. 19) may receive third information indicating CLI measurement information, wherein one or more parameters of the CLI measurement information are based on the first BWP and the one or more subbands, as described above.

Process 1700 may include additional aspects, such as any single aspect or any combination of aspects described below or in connection with one or more other processes described elsewhere herein.

In a first aspect, the one or more parameters include a measurement delay, wherein the first BWP includes first frequency domain resources, wherein the one or more subbands include a first subband and a second subband, wherein the first subband is included in the first frequency domain resources, wherein the second subband is outside of the first frequency domain resources, and wherein the measurement delay is based on an amount of time for multiple CLI measurements based on the second subband being outside of the first frequency domain resources.

In a second aspect, alone or in combination with the first aspect, the one or more parameters include a measurement accuracy, and wherein the measurement accuracy is unmodified based on the multiple CLI measurements.

In a third aspect, alone or in combination with one or more of the first and second aspects, the one or more parameters include a measurement accuracy, wherein the first BWP includes first frequency domain resources, wherein the one or more subbands include a first subband and a second subband, wherein the first subband is included in the first frequency domain resources, wherein the second subband is outside of the first frequency domain resources, wherein the measurement accuracy is based on a skipped CLI measurement that is skipped based on the second subband being outside of the first frequency domain resources.

In a fourth aspect, alone or in combination with one or more of the first through third aspects, the one or more parameters include a measurement delay, and wherein the measurement delay is unmodified based on the skipped CLI measurement.

In a fifth aspect, alone or in combination with one or more of the first through fourth aspects, process 1700 includes transmitting configuration information that indicates a second BWP to be switched to for CLI measurement associated with the CLI measurement resource.

In a sixth aspect, alone or in combination with one or more of the first through fifth aspects, the configuration information is included in the second information.

In a seventh aspect, alone or in combination with one or more of the first through sixth aspects, the first BWP includes first frequency domain resources, wherein the CLI measurement resource includes second frequency domain resources that are included in the first frequency domain resources, and process 1700 includes transmitting, via a one or more second subbands in the first SBFD time interval, one or more signals based on the second frequency domain resources being included in the first frequency domain resources.

In an eighth aspect, alone or in combination with one or more of the first through seventh aspects, the first BWP includes first frequency domain resources, wherein the CLI measurement resource includes second frequency domain resources, wherein the second frequency domain resources are outside of the first frequency domain resources, and process 1700 includes transmitting scheduling information for one or more signals, wherein the scheduling information is subject to one or more conditions that are based on the second frequency domain resources being outside of the first frequency domain resources.

In a ninth aspect, alone or in combination with one or more of the first through eighth aspects, the one or more conditions indicate that the scheduling information is to schedule signals in one or more times that are outside of one or more switch times and the first SBFD time interval based on the second frequency domain resources being outside of the first frequency domain resources.

In a tenth aspect, alone or in combination with one or more of the first through ninth aspects, the one or more switch times are one or more radio frequency retuning times.

In an eleventh aspect, alone or in combination with one or more of the first through tenth aspects, the one or more switch times are one or more radio BWP switching times.

In a twelfth aspect, alone or in combination with one or more of the first through eleventh aspects, the CLI measurement resource is a CLI RSSI measurement resource.

In a thirteenth aspect, alone or in combination with one or more of the first through twelfth aspects, the CLI measurement resource is a CLI SRS RSRP measurement resource.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication. The apparatus 1800 may be a network entity, or a network entity may include the apparatus 1800. In some aspects, the apparatus 1800 includes a reception component 1802, a transmission component 1804, or a communication manager 1806, which may be in communication with one another (for example, via one or more buses or one or more other components). In some aspects, the communication manager 1806 is the communication manager 114, the communication manager 118, or the communication manager 250. As shown, the apparatus 1800 may communicate with another apparatus 1808, such as a UE or a network node (such as a CU, a DU, an RU, or a base station), using the reception component 1802 and the transmission component 1804. The communication manager 1806 may be included in, or implemented via, a processing system (for example, the processing system 110, the processing system 112, or the processing system 240).

In some aspects, the apparatus 1800 may be configured to perform one or more operations described herein in connection with FIGS. 7-13. Additionally, or alternatively, the apparatus 1800 may be configured to perform one or more processes described herein, such as process 1400 of FIG. 14, process 1600 of FIG. 16, or a combination thereof. In some aspects, the apparatus 1800 or one or more components shown in FIG. 18 may include one or more components described in connection with FIGS. 1-2. Additionally, or alternatively, one or more components shown in FIG. 18 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1808. The reception component 1802 may provide received communications to one or more other components of the apparatus 1800. In some aspects, the reception component 1802 may perform signal processing on the received communications, and may provide the processed signals to the one or more other components of the apparatus 1800. In some aspects, the reception component 1802 may include one or more components described above in connection with FIGS. 1-2, such as a radio, one or more RF chains, one or more transceivers, or one or more modems, each of which may in turn be coupled with one or more antennas.

The transmission component 1804 may transmit communications, such as reference signals, control information, data communications, or a combination thereof, to the apparatus 1808. In some aspects, one or more other components of the apparatus 1800 may generate communications and may provide the generated communications to the transmission component 1804 for transmission to the apparatus 1808. In some aspects, the transmission component 1804 may perform signal processing on the generated communications, and may transmit the processed signals to the apparatus 1808. In some aspects, the transmission component 1804 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1804 may be co-located with the reception component 1802.

The communication manager 1806 may support operations of the reception component 1802 or the transmission component 1804. For example, the communication manager 1806 may receive information associated with configuring reception of communications by the reception component 1802 or transmission of communications by the transmission component 1804. Additionally, or alternatively, the communication manager 1806 may generate or provide control information to the reception component 1802 or the transmission component 1804 to control reception or transmission of communications.

The reception component 1802 may receive first information indicating that a first CLI measurement resource is to occur in a first subband of a first SBFD time interval. The reception component 1802 may receive second information indicating that a second CLI measurement resource is to occur in a second subband of a second SBFD time interval. The communication manager 1806 may perform, in accordance with a condition, one or more CLI measurements using at least one of the first CLI measurement resource or the second CLI measurement resource, wherein the condition is evaluated based on the first SBFD time interval and the second SBFD time interval.

The reception component 1802 may receive first information indicating a first BWP. The reception component 1802 may receive second information indicating that a CLI measurement resource is to occur in one or more subbands of a first SBFD time interval. The communication manager 1806 may perform, using the CLI measurement resource, one or more CLI measurements to obtain CLI measurement information, wherein one or more parameters of the CLI measurement information are based on the first BWP and the one or more subbands. The transmission component 1804 may transmit third information indicating the CLI measurement information. The reception component 1802 may receive configuration information that indicates the second BWP.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

FIG. 19 is a diagram of an example apparatus 1900 for wireless communication. The apparatus 1900 may be a network entity, or a network entity may include the apparatus 1900. In some aspects, the apparatus 1900 includes a reception component 1902, a transmission component 1904, or a communication manager 1906, which may be in communication with one another (for example, via one or more buses or one or more other components). In some aspects, the communication manager 1906 is the communication manager 114, the communication manager 118, or the communication manager 255. As shown, the apparatus 1900 may communicate with another apparatus 1908, such as a UE or a network node (such as a CU, a DU, an RU, or a base station), using the reception component 1902 and the transmission component 1904. The communication manager 1906 may be included in, or implemented via, a processing system (for example, the processing system 110, the processing system 112, or the processing system 245).

In some aspects, the apparatus 1900 may be configured to perform one or more operations described herein in connection with FIGS. 7-13. Additionally, or alternatively, the apparatus 1900 may be configured to perform one or more processes described herein, such as process 1500 of FIG. 15, process 1700 of FIG. 17, or a combination thereof. In some aspects, the apparatus 1900 or one or more components shown in FIG. 19 may include one or more components described in connection with FIGS. 1-2. Additionally, or alternatively, one or more components shown in FIG. 19 may be implemented within one or more components described in connection with FIGS. 1-2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications, and may provide the processed signals to the one or more other components of the apparatus 1900. In some aspects, the reception component 1902 may include one or more components described above in connection with FIGS. 1-2, such as a radio, one or more RF chains, one or more transceivers, or one or more modems, each of which may in turn be coupled with one or more antennas.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications, and may transmit the processed signals to the apparatus 1908. In some aspects, the transmission component 1904 may include one or more components described above in connection with FIGS. 1-2, such as a radio, one or more RF chains, one or more transceivers, or one or more modems, each of which may in turn be coupled with one or more antennas described in connection with FIGS. 1-2. In some aspects, the transmission component 1904 may be co-located with the reception component 1902.

The communication manager 1906 may support operations of the reception component 1902 or the transmission component 1904. For example, the communication manager 1906 may receive information associated with configuring reception of communications by the reception component 1902 or transmission of communications by the transmission component 1904. Additionally, or alternatively, the communication manager 1906 may generate or provide control information to the reception component 1902 or the transmission component 1904 to control reception or transmission of communications.

The transmission component 1904 may transmit first information, for a second network entity, indicating that a first CLI measurement resource is to occur in a first subband of a first SBFD time interval. The transmission component 1904 may transmit, based on a condition being satisfied, second information, for the second network entity, indicating that a second CLI measurement resource is to occur in a second subband of a second SBFD time interval, wherein the condition is evaluated based on the first SBFD time interval and the second SBFD time interval.

The transmission component 1904 may transmit first information indicating a first BWP. The transmission component 1904 may transmit second information indicating that a CLI measurement resource is to occur in one or more subbands of a first SBFD time interval. The reception component 1902 may receive third information indicating CLI measurement information, wherein one or more parameters of the CLI measurement information are based on the first BWP and the one or more subbands.

The transmission component 1904 may transmit configuration information that indicates a second BWP to be switched to for CLI measurement associated with the CLI measurement resource.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

The following provides an overview of some Aspects of the present disclosure:
Aspect 1: A method of wireless communication performed by a network entity, comprising: receiving first information indicating that a first cross-link interference (CLI) measurement resource is to occur in a first subband of a first subband full duplex (SBFD) time interval; receiving second information indicating that a second CLI measurement resource is to occur in a second subband of a second SBFD time interval; and performing, in accordance with a condition, one or more CLI measurements using at least one of the first CLI measurement resource or the second CLI measurement resource, wherein the condition is evaluated based on the first SBFD time interval and the second SBFD time interval.
Aspect 2: The method of Aspect 1, wherein the condition is satisfied based on the first SBFD time interval and the second SBFD time interval being different time intervals, and wherein performing the one or more CLI measurements comprises: performing, based on the condition being satisfied and during the first SBFD time interval, a first set of one or more CLI measurements using the first CLI measurement resource; and performing, based on the condition being satisfied and during the second SBFD time interval, a second set of one or more CLI measurements using the second CLI measurement resource.
Aspect 3: The method of any of Aspects 1-2, wherein the second SBFD time interval at least partially overlaps in time with the first SBFD time interval, wherein the condition is not satisfied based on the second SBFD time interval at least partially overlapping in time with the first SBFD time interval, and wherein performing the one or more CLI measurements comprises: performing, based on the condition not being satisfied, the one or more CLI measurements using only one of the first CLI measurement resource or the second CLI measurement resource.
Aspect 4: The method of any of Aspects 1-3, wherein the first CLI measurement resource is a CLI received signal strength indicator (RSSI) measurement resource, wherein the first subband includes one or more downlink subbands, wherein the second CLI measurement resource is a CLI sounding reference signal (SRS) reference signal received power (RSRP) measurement resource, and wherein the second subband includes one or more uplink subbands.
Aspect 5: The method of any of Aspects 1-4, wherein the first CLI measurement resource is a CLI received signal strength indicator (RSSI) measurement resource, wherein the first subband includes an uplink subband, wherein the second CLI measurement resource is a CLI sounding reference signal (SRS) reference signal received power (RSRP) measurement resource, and wherein the second subband includes the uplink subband.
Aspect 6: The method of Aspect 5, wherein the condition indicates that a first set of one or more frequency resources for the CLI RSSI measurement resource are to be different than a second set of one or more frequency resources for the CLI SRS RSRP measurement resource.
Aspect 7: The method of any of Aspects 1-6, wherein the second SBFD time interval at least partially overlaps in time with the first SBFD time interval, and wherein the condition is satisfied based on a capability of the network entity, wherein the capability is that the network entity supports reception of a downlink signal in a downlink subband of an SBFD time interval and sounding reference signal (SRS) reference signal received power (RSRP) CLI measurement in an uplink subband of the SBFD time interval.
Aspect 8: The method of Aspect 7, wherein performing the one or more CLI measurements comprises: performing, based on the condition being satisfied and during the first SBFD time interval, a first set of one or more CLI measurements using the first CLI measurement resource; and performing, based on the condition being satisfied and during the second SBFD time interval, a second set of one or more CLI measurements using the second CLI measurement resource.
Aspect 9: The method of any of Aspects 1-8, wherein the first CLI measurement resource is a CLI received signal strength indicator (RSSI) measurement resource, wherein one or more downlink subbands of the first SBFD time interval is free of scheduled or configured downlink signals, and wherein the condition is satisfied based on the one or more downlink subbands of the first SBFD time interval being free of scheduled or configured downlink signals.
Aspect 10: The method of any of Aspects 1-9, wherein the first CLI measurement resource is a CLI received signal strength indicator (RSSI) measurement resource, the method further comprising receiving third information indicating that a downlink signal is to occur in a downlink subband of the first SBFD time interval, and wherein performing the one or more CLI measurements comprises: performing, based on a capability of the network entity and during the first SBFD time interval, the one or more CLI measurements, wherein the capability is that the network entity supports reception of downlink signals and RSSI CLI measurement in a same SBFD time interval.
Aspect 11: A method of wireless communication performed by a first network entity, comprising: transmitting first information, for a second network entity, indicating that a first cross-link interference (CLI) measurement resource is to occur in a first subband of a first subband full duplex (SBFD) time interval; and transmitting, based on a condition being satisfied, second information, for the second network entity, indicating that a second CLI measurement resource is to occur in a second subband of a second SBFD time interval, wherein the condition is evaluated based on the first SBFD time interval and the second SBFD time interval.
Aspect 12: The method of Aspect 11, wherein the condition is satisfied based on the first SBFD time interval and the second SBFD time interval being different time intervals.
Aspect 13: The method of any of Aspects 11-12, wherein the first CLI measurement resource is a CLI received signal strength indicator (RSSI) measurement resource, wherein the first subband includes one or more downlink subbands, wherein the second CLI measurement resource is a CLI sounding reference signal (SRS) reference signal received power (RSRP) measurement resource, and wherein the second subband includes one or more uplink subbands.
Aspect 14: The method of any of Aspects 11-13, wherein the first CLI measurement resource is a CLI received signal strength indicator (RSSI) measurement resource, wherein the first subband includes an uplink subband, wherein the second CLI measurement resource is a CLI sounding reference signal (SRS) reference signal received power (RSRP) measurement resource, and wherein the second subband includes the uplink subband.
Aspect 15: The method of Aspect 14, wherein the CLI RSSI measurement resource includes a first set of one or more frequency domain resources in the uplink subband, wherein the CLI SRS RSRP measurement resource includes a second set of one or more frequency domain resources in the uplink subband, wherein the first set of one or more frequency domain resources is different than the second set of one or more frequency domain resources, and wherein the condition is satisfied based on the first set of one or more frequency domain resources being different than the second set of one or more frequency domain resources.
Aspect 16: The method of any of Aspects 11-15, wherein the second SBFD time interval at least partially overlaps in time with the first SBFD time interval, and wherein the condition is satisfied based on a capability of the second network entity, wherein the capability is that the second network entity supports reception of a downlink signal in a downlink subband of an SBFD time interval and sounding reference signal (SRS) reference signal received power (RSRP) CLI measurement in an uplink subband of the SBFD time interval.
Aspect 17: The method of any of Aspects 11-16, wherein the first CLI measurement resource is a CLI received signal strength indicator (RSSI) measurement resource, wherein one or more downlink subbands of the first SBFD time interval is free of scheduled or configured downlink signals, and wherein the condition is satisfied based on the one or more downlink subbands of the first SBFD time interval being free of scheduled or configured downlink signals.
Aspect 18: The method of any of Aspects 11-17, wherein the first CLI measurement resource is a CLI received signal strength indicator (RSSI) measurement resource, the method further comprising transmitting, based on a capability of the second network entity, third information indicating that a downlink signal is to occur in a downlink subband of the first SBFD time interval, wherein the capability is that the second network entity supports reception of downlink signals and RSSI CLI measurement in a same SBFD time interval.
Aspect 19: A method of wireless communication performed by a network entity, comprising: receiving first information indicating a first bandwidth part (BWP); receiving second information indicating that a cross-link interference (CLI) measurement resource is to occur in one or more subbands of a first subband full duplex (SBFD) time interval; performing, using the CLI measurement resource, one or more CLI measurements to obtain CLI measurement information, wherein one or more parameters of the CLI measurement information are based on the first BWP and the one or more subbands; and transmitting third information indicating the CLI measurement information.
Aspect 20: The method of Aspect 19, wherein the one or more parameters include a measurement delay, wherein the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements comprises: performing, using the first subband and the first SBFD time interval, a first CLI measurement; and performing, using the second subband and a second SBFD time interval, a second CLI measurement, wherein the measurement delay is based on an amount of time to perform first CLI measurement and the second CLI measurement.
Aspect 21: The method of Aspect 20, wherein the one or more parameters include a measurement accuracy, and wherein the measurement accuracy is unmodified based on the first CLI measurement and the second CLI measurement being performed.
Aspect 22: The method of any of Aspects 19-21, wherein the one or more parameters include a measurement accuracy, wherein the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements comprises: performing, using the first subband and the first SBFD time interval, a first CLI measurement; and skipping performance of a second CLI measurement using the second subband, wherein the measurement accuracy is based on the second CLI measurement being skipped.
Aspect 23: The method of Aspect 22, wherein the one or more parameters include a measurement delay, and wherein the measurement delay is unmodified based on the second CLI measurement being skipped.
Aspect 24: The method of any of Aspects 19-23, wherein the first BWP includes first frequency domain resources, wherein the one or more subbands include a first subband and a second subband, wherein the first subband is included in the first frequency domain resources, wherein the second subband is outside of the first frequency domain resources, and wherein performing the one or more CLI measurements comprises: switching from the first BWP to a second BWP, wherein the second BWP includes second frequency domain resources, and wherein both the first subband and the second subband are included in the second frequency domain resources; and performing, using the second BWP and during the first SBFD time interval, the one or more CLI measurements, wherein the one or more parameters are based on the one or more CLI measurements.
Aspect 25: The method of Aspect 24, further comprising: receiving configuration information that indicates the second BWP.
Aspect 26: The method of Aspect 25, wherein the configuration information is included in the second information.
Aspect 27: The method of any of Aspects 19-26, wherein the first BWP includes first frequency domain resources, wherein the CLI measurement resource includes second frequency domain resources that are included in the first frequency domain resources, and the method further comprising: receiving, via a one or more second subbands in the first SBFD time interval, one or more signals based on the second frequency domain resources being included in the first frequency domain resources.
Aspect 28: The method of any of Aspects 19-27, wherein the first BWP includes first frequency domain resources, wherein the CLI measurement resource includes second frequency domain resources, wherein the second frequency domain resources are outside of the first frequency domain resources, and the method further comprising: receiving scheduling information for one or more signals, wherein the scheduling information is subject to one or more conditions that are based on the second frequency domain resources being outside of the first frequency domain resources.
Aspect 29: The method of Aspect 28, wherein performing the one or more CLI measurements comprises: performing, during one or more switch times, one or more switches between the first frequency domain resources and the second frequency domain resources, wherein the one or more conditions indicate that the scheduling information is to schedule signals in one or more times that are outside of the one or more switch times and the first SBFD time interval.
Aspect 30: The method of Aspect 29, wherein the one or more switch times are one or more radio frequency retuning times.
Aspect 31: The method of Aspect 29, wherein the one or more switch times are one or more radio BWP switching times.
Aspect 32: The method of any of Aspects 19-31, wherein the CLI measurement resource is a CLI received signal strength indicator (RSSI) measurement resource.
Aspect 33: The method of any of Aspects 19-32, wherein the CLI measurement resource is a CLI sounding reference signal (SRS) reference signal received power (RSRP) measurement resource.
Aspect 34: A method of wireless communication performed by a network entity, comprising: transmitting first information indicating a first bandwidth part (BWP); transmitting second information indicating that a cross-link interference (CLI) measurement resource is to occur in one or more subbands of a first subband full duplex (SBFD) time interval; and receiving third information indicating CLI measurement information, wherein one or more parameters of the CLI measurement information are based on the first BWP and the one or more subbands.
Aspect 35: The method of Aspect 34, wherein the one or more parameters include a measurement delay, wherein the first BWP includes first frequency domain resources, wherein the one or more subbands include a first subband and a second subband, wherein the first subband is included in the first frequency domain resources, wherein the second subband is outside of the first frequency domain resources, and wherein the measurement delay is based on an amount of time for multiple CLI measurements based on the second subband being outside of the first frequency domain resources.
Aspect 36: The method of Aspect 35, wherein the one or more parameters include a measurement accuracy, and wherein the measurement accuracy is unmodified based on the multiple CLI measurements.
Aspect 37: The method of any of Aspects 34-36, wherein the one or more parameters include a measurement accuracy, wherein the first BWP includes first frequency domain resources, wherein the one or more subbands include a first subband and a second subband, wherein the first subband is included in the first frequency domain resources, wherein the second subband is outside of the first frequency domain resources, wherein the measurement accuracy is based on a skipped CLI measurement that is skipped based on the second subband being outside of the first frequency domain resources.
Aspect 38: The method of Aspect 37, wherein the one or more parameters include a measurement delay, and wherein the measurement delay is unmodified based on the skipped CLI measurement.
Aspect 39: The method of any of Aspects 34-38, further comprising: transmitting configuration information that indicates a second BWP to be switched to for CLI measurement associated with the CLI measurement resource.
Aspect 40: The method of Aspect 39, wherein the configuration information is included in the second information.
Aspect 41: The method of any of Aspects 34-40, wherein the first BWP includes first frequency domain resources, wherein the CLI measurement resource includes second frequency domain resources that are included in the first frequency domain resources, and the method further comprising: transmitting, via a one or more second subbands in the first SBFD time interval, one or more signals based on the second frequency domain resources being included in the first frequency domain resources.
Aspect 42: The method of any of Aspects 34-41, wherein the first BWP includes first frequency domain resources, wherein the CLI measurement resource includes second frequency domain resources, wherein the second frequency domain resources are outside of the first frequency domain resources, and the method further comprising: transmitting scheduling information for one or more signals, wherein the scheduling information is subject to one or more conditions that are based on the second frequency domain resources being outside of the first frequency domain resources.
Aspect 43: The method of Aspect 42, wherein the one or more conditions indicate that the scheduling information is to schedule signals in one or more times that are outside of one or more switch times and the first SBFD time interval based on the second frequency domain resources being outside of the first frequency domain resources.
Aspect 44: The method of Aspect 43, wherein the one or more switch times are one or more radio frequency retuning times.
Aspect 45: The method of Aspect 43, wherein the one or more switch times are one or more radio BWP switching times.
Aspect 46: The method of any of Aspects 34-45, wherein the CLI measurement resource is a CLI received signal strength indicator (RSSI) measurement resource.
Aspect 47: The method of any of Aspects 34-46, wherein the CLI measurement resource is a CLI sounding reference signal (SRS) reference signal received power (RSRP) measurement resource.
Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-47.
Aspect 49: An apparatus for wireless communication at a device, the apparatus comprising one or more memories and one or more processors coupled to the one or more memories, the one or more processors configured to cause the device to perform the method of one or more of Aspects 1-47.
Aspect 50: An apparatus for wireless communication, the apparatus comprising at least one means for performing the method of one or more of Aspects 1-47.
Aspect 51: A non-transitory computer-readable medium storing code for wireless communication, the code comprising instructions executable by one or more processors to perform the method of one or more of Aspects 1-47.
Aspect 52: A non-transitory computer-readable medium storing a set of instructions for wireless communication, the set of instructions comprising one or more instructions that, when executed by one or more processors of a device, cause the device to perform the method of one or more of Aspects 1-47.
Aspect 53: A device for wireless communication, the device comprising a processing system that includes one or more processors and one or more memories coupled with the one or more processors, the processing system configured to cause the device to perform the method of one or more of Aspects 1-47.
Aspect 54: An apparatus for wireless communication at a device, the apparatus comprising one or more memories and one or more processors coupled to the one or more memories, the one or more processors individually or collectively configured to cause the device to perform the method of one or more of Aspects 1-47.
Aspect 55: A device comprising a processing system that includes one or more processors and one or more code-storing memories coupled with the one or more processors, the processing system configured to cause the device to perform the method of one or more of Aspects 1-47.
Aspect 56: A device comprising a processing system that includes processor circuitry and code-storing memory circuitry, the processing system configured to cause the device to perform the method of one or more of Aspects 1-47.
Aspect 57: A device for wireless communication, the device comprising a processing system, the processing system configured to perform the method of one or more of Aspects 1-47.
Aspect 58: A non-transitory computer-readable medium having code thereon that, when executed by a device, causes the device to perform the method of one or more of Aspects 1-47.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

Systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network entity, comprising:
a processing system configured to:
receive first information indicating that a first cross-link interference (CLI) measurement resource is to occur in a first subband full duplex (SBFD) time interval;
receive second information indicating that a second CLI measurement resource is to occur in a second SBFD time interval; and
perform, in accordance with a condition, one or more CLI measurements using at least one of the first CLI measurement resource or the second CLI measurement resource, wherein the condition is evaluated based on the first SBFD time interval and the second SBFD time interval.

2. The network entity of claim 1, wherein the condition is satisfied based on the first SBFD time interval and the second SBFD time interval being different time intervals.

3. The network entity of claim 2, wherein to perform the one or more CLI measurements, the processing system is configured to:
perform, based on the condition being satisfied and during the first SBFD time interval, a first set of one or more CLI measurements using the first CLI measurement resource; and
perform, based on the condition being satisfied and during the second SBFD time interval, a second set of one or more CLI measurements using the second CLI measurement resource.

4. The network entity of claim 1, wherein the second SBFD time interval at least partially overlaps in time with the first SBFD time interval, wherein the condition is not satisfied based on the second SBFD time interval at least partially overlapping in time with the first SBFD time interval.

5. The network entity of claim 4, wherein to perform the one or more CLI measurements, the processing system is configured to:
perform, based on the condition not being satisfied, the one or more CLI measurements using only one of the first CLI measurement resource or the second CLI measurement resource.

6. The network entity of claim 1, wherein the first CLI measurement resource is a CLI received signal strength indicator (RSSI) measurement resource, and wherein the second CLI measurement resource is a CLI sounding reference signal (SRS) reference signal received power (RSRP) measurement resource.

7. The network entity of claim 6, wherein the condition indicates a first set of one or more frequency resources for the CLI RSSI measurement resource are to be different than a second set of one or more frequency resources for the CLI SRS RSRP measurement resource.

8. The network entity of claim 1, wherein the second SBFD time interval at least partially overlaps in time with the first SBFD time interval, and wherein the condition is satisfied based on a capability of the network entity, wherein the capability is that the network entity supports reception of a downlink signal in a downlink subband of an SBFD time interval and sounding reference signal (SRS) reference signal received power (RSRP) CLI measurement in an uplink subband of the SBFD time interval.

9. The network entity of claim 8, wherein, to perform the one or more CLI measurements, the processing system is configured to:
perform, based on the condition being satisfied and during the first SBFD time interval, a first set of one or more CLI measurements using the first CLI measurement resource; and
perform, based on the condition being satisfied and during the second SBFD time interval, a second set of one or more CLI measurements using the second CLI measurement resource.

10. The network entity of claim 1, wherein the first CLI measurement resource is a CLI received signal strength indicator (RSSI) measurement resource, wherein one or more downlink subbands of the first SBFD time interval is free of scheduled or configured downlink signals, and wherein the condition is satisfied based on the one or more downlink subbands of the first SBFD time interval being free of scheduled or configured downlink signals.

11. The network entity of claim 1, wherein the first CLI measurement resource is a CLI received signal strength indicator (RSSI) measurement resource, wherein the processing system is configured to receive third information indicating that a downlink signal is to occur in a downlink subband of the first SBFD time interval, and wherein, to perform the one or more CLI measurements, the processing system is configured to:
perform, based on a capability of the network entity and during the first SBFD time interval, the one or more CLI measurements, wherein the capability is that the network entity supports reception of downlink signals and RSSI CLI measurement in a same SBFD time interval.

12. A first network entity, comprising:
a processing system configured to:
transmit first information, for a second network entity, indicating that a first cross-link interference (CLI) measurement resource is to occur in a first subband full duplex (SBFD) time interval; and
transmit, based on a condition being satisfied, second information, for the second network entity, indicating that a second cross-link interference (CLI) measurement resource is to occur in a second SBFD time interval, wherein the condition is evaluated based on the first SBFD time interval and the second SBFD time interval.

13. The first network entity of claim 12, wherein the condition is satisfied based on the first SBFD time interval and the second SBFD time interval being different time intervals.

14. The first network entity of claim 12, wherein the first CLI measurement resource is a CLI received signal strength indicator (RSSI) measurement resource, and wherein the second CLI measurement resource is a CLI sounding reference signal (SRS) reference signal received power (RSRP) measurement resource.

15. The first network entity of claim 12, wherein the second SBFD time interval at least partially overlaps in time with the first SBFD time interval, and wherein the condition is satisfied based on a capability of the second network entity, wherein the capability is that the second network entity supports reception of a downlink signal in a downlink subband of an SBFD time interval and sounding reference signal (SRS) reference signal received power (RSRP) CLI measurement in an uplink subband of the SBFD time interval.

16. A method of wireless communication performed by a network entity, comprising:
receiving first information indicating that a first cross-link interference (CLI) measurement resource is to occur in a first subband full duplex (SBFD) time interval;
receiving second information indicating that a second CLI measurement resource is to occur in a second SBFD time interval; and
performing, in accordance with a condition, one or more CLI measurements using at least one of the first CLI measurement resource or the second CLI measurement resource, wherein the condition is evaluated based on the first SBFD time interval and the second SBFD time interval.

17. The method of claim 16, wherein the condition is satisfied based on the first SBFD time interval and the second SBFD time interval being different time intervals.

18. The method of claim 16, wherein the second SBFD time interval at least partially overlaps in time with the first SBFD time interval, wherein the condition is not satisfied based on the second SBFD time interval at least partially overlapping in time with the first SBFD time interval.

19. The method of claim 18, wherein performing the one or more CLI measurements comprises:
performing, based on the condition not being satisfied, the one or more CLI measurements using only one of the first CLI measurement resource or the second CLI measurement resource.

20. The method of claim 16, wherein the condition indicates that a first set of one or more frequency resources for the CLI RSSI measurement resource are to be different than a second set of one or more frequency resources for the CLI SRS RSRP measurement resource.
